(19) United States
(12) Patent Application Publication
(10) Pub. No.: US 2014/0143193 A1
(43) Pub. Date: May 22, 2014

(54) METHOD AND APPARATUS FOR DESIGNING EMERGENT MULTI-LAYER SPIKING NETWORKS

(71) Applicant: QUALCOMM INCORPORATED, San Diego, CA (US)

(72) Inventors: Thomas Zheng, San Diego, CA (US); Jason Frank Hunzinger, Escondido, CA (US)

(73) Assignee: QUALCOMM Incorporated, San Diego, CA (US)

(21) Appl. No.: 13/804,299

(22) Filed: Mar. 14, 2013

Related U.S. Application Data
(60) Provisional application No. 61/728,409, filed on Nov. 20, 2012.

(51) Int. Cl. G06N 3/08

(52) U.S. Cl. CPC G06N 3/08
USPC 706/25

(57) ABSTRACT

Certain aspects of the present disclosure support a technique for designing an emergent multi-layer spiking neural network. Parameters of the neural network can be first determined based upon desired one or more functional features of the neural network. Then, the one or more functional features can be developed towards the desired functional features as the determined parameters are further adapted, tuned and updated. The parameters can comprise at least one of time constants of neuron circuits of the neural network, time constants of synapse connections of the neural network, timing parameters of the neural network, or timing aspects of learning in the neural network. The one or more functional features can comprise at least one of feature detection in a layer of the multi-layer spiking neural network or saliency detection in another layer of the multi-layer spiking neural network.

### CLAIM OF PRIORITY UNDER 35 U.S.C. §119

The present Application for Patent claims benefit of Provisional Application Ser. No. 61/728,409 filed Nov. 20, 2012, and assigned to the assignee hereof and hereby expressly incorporated by reference herein.

### BACKGROUND

1. Field

Certain aspects of the present disclosure generally relate to neural system engineering and, more particularly, to a method and apparatus for designing emergent multi-layer spiking networks.

2. Background

An artificial neural network, which may comprise an interconnected group of artificial neurons (i.e., neuron models), is a computational device or represents a method to be performed by a computational device. Artificial neural networks may have corresponding structure and/or function in biological neural networks. However, artificial neural networks may provide innovative and useful computational techniques for certain applications in which traditional computational techniques are cumbersome, impractical, or inadequate. Because artificial neural networks can infer a function from observations, such networks are particularly useful in applications where the complexity of the task or data makes the design of the function by conventional techniques burdensome.

One type of artificial neural network is the spiking neural network, which incorporates the concept of time into its operating model, as well as neuronal and synaptic state, thereby providing a rich set of behaviors from which computational function can emerge in the neural network. Spiking neural networks are based on the concept that neurons fire or “spike” at a particular time or times based on the state of the neuron, and that the time is important to neuron function. When a neuron fires, it generates a spike that travels to other neurons, which, in turn, may adjust their states based on the time this spike is received. In other words, information may be encoded in the relative or absolute timing of spikes in the neural network.

### SUMMARY

Certain aspects of the present disclosure provide a method of designing an emergent multi-layer spiking neural network. The method generally includes determining parameters of the neural network based upon desired one or more functional features of the neural network and developing the one or more functional features towards the desired functional features as the determined parameters are further adapted, tuned and updated.

Certain aspects of the present disclosure provide an apparatus for designing an emergent multi-layer spiking neural network. The apparatus generally includes a first circuit configured to determine parameters of the neural network based upon desired one or more functional features of the neural network, and a second circuit configured to develop the one or more functional features towards the desired functional features as the determined parameters are further adapted, tuned and updated.

Certain aspects of the present disclosure provide an apparatus for designing an emergent multi-layer spiking neural network. The apparatus generally includes means for determining parameters of the neural network based upon desired one or more functional features of the neural network and means for developing the one or more functional features towards the desired functional features as the determined parameters are further adapted, tuned and updated.

Certain aspects of the present disclosure provide a computer program product for designing an emergent multi-layer spiking neural network. The computer program product generally includes a computer-readable medium comprising code for determining parameters of the neural network based upon desired one or more functional features of the neural network and code for developing the one or more functional features towards the desired functional features as the determined parameters are further adapted, tuned and updated.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates an example network of neurons in accordance with certain aspects of the present disclosure.

FIG. 2 illustrates example of a processing unit (neuron) of a computational network (neural system or neural network) in accordance with certain aspects of the present disclosure.

FIG. 3 illustrates an example of a positive regime and a negative regime for defining behavior of the model, in accordance with certain aspects of the present disclosure.

FIG. 4 illustrates an example architectural template of a multi-layer neural network in accordance with certain aspects of the present disclosure.

FIG. 5 illustrates an example of spike-timing dependent plasticity (STDP) curve in accordance with certain aspects of the present disclosure.

FIG. 6 illustrates an example activity of excitatory sub-layer neurons and inhibitory sub-layer neurons of a multi-layer spiking neural network in accordance with certain aspects of the present disclosure.

FIG. 7 illustrates an example architectural template for long-range inhibitory emergence in a multi-layer spiking neural network in accordance with certain aspects of the present disclosure.

FIG. 8 illustrates another example of STDP curve in accordance with certain aspects of the present disclosure.

FIG. 9 illustrates an example of desirable output from excitatory neurons in accordance with certain aspects of the present disclosure.

FIG. 10 illustrates an example timing distribution of popout spikes and distractors in accordance with certain aspects of the present disclosure.

FIG. 11 illustrates an example sample of receptive fields for a group of neurons in accordance with certain aspects of the present disclosure.

FIG. 12 illustrates examples of orientation feature of excitatory neurons, orientation distribution and circular variance distribution in accordance with certain aspects of the present disclosure.

FIG. 13 illustrates an example of orientation distribution of synaptic weights in accordance with certain aspects of the present disclosure.

FIG. 14 illustrates an example of suppressed activity of excitatory neuron sub-layer and an example activity of connected long-range inhibitory neuron sub-layer in accordance with certain aspects of the present disclosure.

FIG. 15 illustrates example distribution of synaptic weights associated with long-range inhibitory fan-out connections in accordance with certain aspects of the present disclosure.

FIG. 16 illustrates example responses of two neurons during popout tests in accordance with certain aspects of the present disclosure.

FIG. 17 illustrates examples of cumulative spike activities during different popout trials in accordance with certain aspects of the present disclosure.

FIG. 18 illustrates an example performance of the popout scheme in accordance with certain aspects of the present disclosure.

FIG. 19 illustrates example operations for designing an emergent multi-layer spiking neural network in accordance with certain aspects of the present disclosure.

FIG. 19A illustrates example components capable of performing the operations illustrated in FIG. 19.

FIG. 20 illustrates an example implementation of designing an emergent multi-layer spiking neural network using a general-purpose processor in accordance with certain aspects of the present disclosure.

FIG. 21 illustrates an example implementation of designing an emergent multi-layer spiking neural network where a memory may be interfaced with individual distributed processing units in accordance with certain aspects of the present disclosure.

FIG. 22 illustrates an example implementation of designing an emergent multi-layer spiking neural network based on distributed memories and distributed processing units in accordance with certain aspects of the present disclosure.

FIG. 23 illustrates an example implementation of a neural network in accordance with certain aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Neural System, Training and Operation

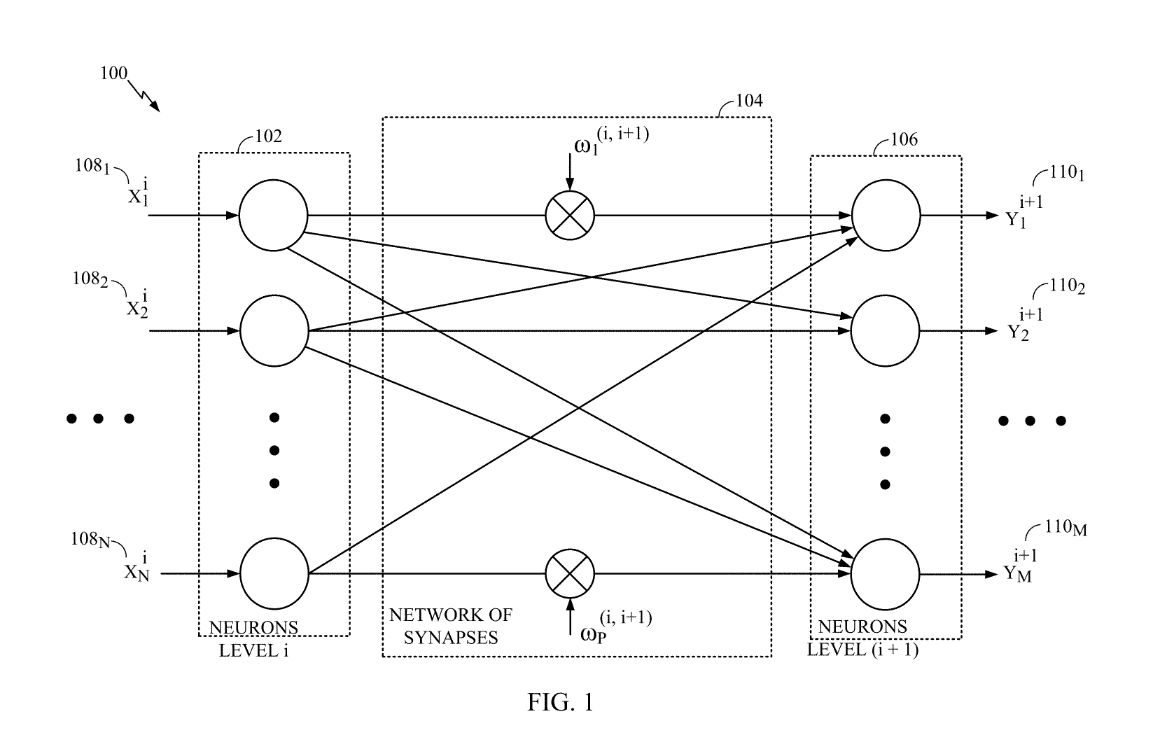

FIG. 1 illustrates an example neural system 100 with multiple levels of neurons in accordance with certain aspects of the present disclosure. The neural system 100 may comprise a level of neurons 102 connected to another level of neurons 106 though a network of synaptic connections 104 (i.e., feed-forward connections). For simplicity, only two levels of neurons are illustrated in FIG. 1, although fewer or more levels of neurons may exist in a typical neural system. It should be noted that some of the neurons may connect to other neurons of the same layer through lateral connections. Furthermore, some of the neurons may connect back to a neuron of a previous layer through feedback connections.

As illustrated in FIG. 1, each neuron in the level 102 may receive an input signal 108 that may be generated by a plurality of neurons of a previous level (not shown in FIG. 1). The signal 108 may represent an input current of the level 102 neuron. This current may be accumulated on the neuron membrane to charge a membrane potential. When the membrane potential reaches its threshold value, the neuron may fire and generate an output spike to be transferred to the next level of neurons (e.g., the level 106). Such behavior can be emulated or simulated in hardware and/or software, including analog and digital implementations.

In biological neurons, the output spike generated when a neuron fires is referred to as an action potential. This electrical signal is a relatively rapid, transient, all-or nothing nerve impulse, having an amplitude of roughly 100 mV and a duration of about 1 ms. In a particular embodiment of a neural system having a series of connected neurons (e.g., the transfer of spikes from one level of neurons to another in FIG. 1), every action potential has basically the same amplitude and duration, and thus, the information in the signal is represented only by the frequency and number of spikes, or the time of spikes, not by the amplitude. The information carried by an action potential is determined by the spike, the neuron that spiked, and the time of the spike relative to other spike or spikes.

The transfer of spikes from one level of neurons to another may be achieved through the network of synaptic connections (or simply “synapses”) 104, as illustrated in FIG. 1. The synapses 104 may receive output signals (i.e., spikes) from the level 102 neurons (pre-synaptic neurons relative to the synapses 104), and scale those signals according to adjustable synaptic weights w₁^{(i,i+1)}, . . . , w_{P}^{(i,i+1)} (where P is a total number of synaptic connections between the neurons of levels 102 and 106). Further, the scaled signals may be combined as an input signal of each neuron in the level 106 (post-synaptic neurons relative to the synapses 104). Every neuron in the level 106 may generate output spikes 110 based on the corresponding combined input signal. The output spikes 110 may be then transferred to another level of neurons using another network of synaptic connections (not shown in FIG. 1).

Biological synapses may be classified as either electrical or chemical. While electrical synapses are used primarily to send excitatory signals, chemical synapses can mediate either excitatory or inhibitory (hyperpolarizing) actions in postsynaptic neurons and can also serve to amplify neuronal signals. Excitatory signals typically depolarize the membrane potential (i.e., increase the membrane potential with respect to the resting potential). If enough excitatory signals are received within a certain time period to depolarize the membrane potential above a threshold, an action potential occurs in the postsynaptic neuron. In contrast, inhibitory signals generally hyperpolarize (i.e., lower) the membrane potential Inhibitory signals, if strong enough, can counteract the sum of excitatory signals and prevent the membrane potential from reaching threshold. In addition to counteracting synaptic excitation, synaptic inhibition can exert powerful control over spontaneously active neurons. A spontaneously active neuron refers to a neuron that spikes without further input, for example due to its dynamics or a feedback. By suppressing the spontaneous generation of action potentials in these neurons, synaptic inhibition can shape the pattern of firing in a neuron, which is generally referred to as sculpturing. The various synapses 104 may act as any combination of excitatory or inhibitory synapses, depending on the behavior desired.

The neural system 100 may be emulated by a general purpose processor, a digital signal processor (DSP), an application specific integrated circuit (ASIC), a field programmable gate array (FPGA) or other programmable logic device (PLD), discrete gate or transistor logic, discrete hardware components, a software module executed by a processor, or any combination thereof. The neural system 100 may be utilized in a large range of applications, such as image and pattern recognition, machine learning, motor control, and alike. Each neuron in the neural system 100 may be implemented as a neuron circuit. The neuron membrane charged to the threshold value initiating the output spike may be implemented, for example, as a capacitor that integrates an electrical current flowing through it.

In an aspect, the capacitor may be eliminated as the electrical current integrating device of the neuron circuit, and a smaller memristor element may be used in its place. This approach may be applied in neuron circuits, as well as in various other applications where bulky capacitors are utilized as electrical current integrators. In addition, each of the synapses 104 may be implemented based on a memristor element, wherein synaptic weight changes may relate to changes of the memristor resistance. With nanometer feature-sized memristors, the area of neuron circuit and synapses may be substantially reduced, which may make implementation of a very large-scale neural system hardware implementation practical.

Functionality of a neural processor that emulates the neural system 100 may depend on weights of synaptic connections, which may control strengths of connections between neurons. The synaptic weights may be stored in a non-volatile memory in order to preserve functionality of the processor after being powered down. In an aspect, the synaptic weight memory may be implemented on a separate external chip from the main neural processor chip. The synaptic weight memory may be packaged separately from the neural processor chip as a replaceable memory card. This may provide diverse functionalities to the neural processor, wherein a particular functionality may be based on synaptic weights stored in a memory card currently attached to the neural processor.

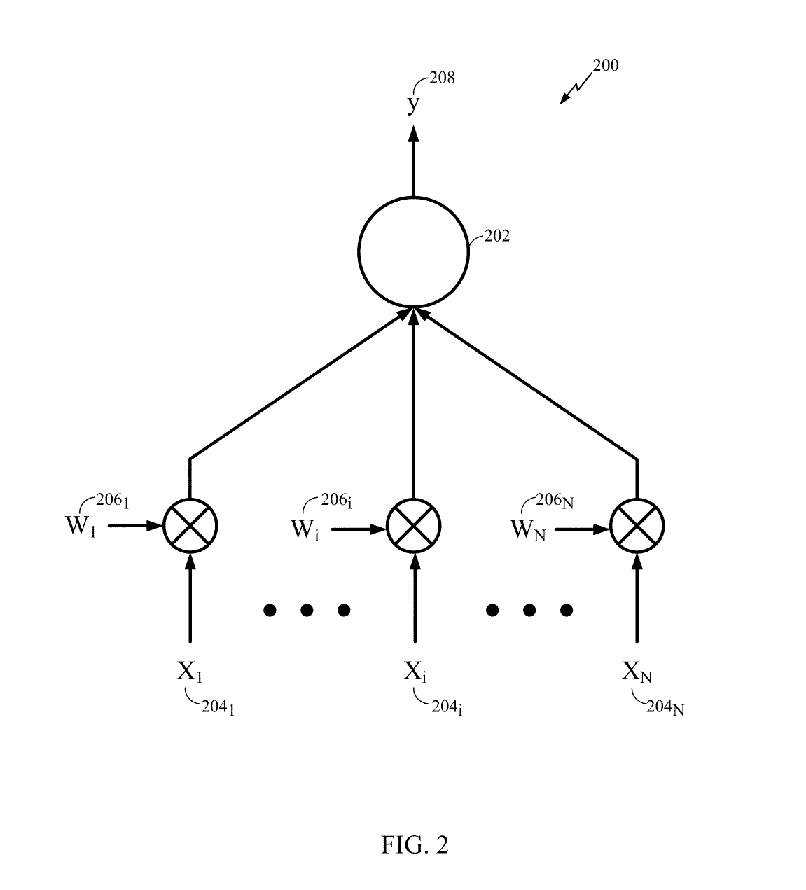

FIG. 2 illustrates an example 200 of a processing unit (e.g., a neuron or neuron circuit) 202 of a computational network (e.g., a neural system or a neural network) in accordance with certain aspects of the present disclosure. For example, the neuron 202 may correspond to any of the neurons of levels 102 and 106 from FIG. 1. The neuron 202 may receive multiple input signals 204₁-204_{N} (x₁-x_{N}), which may be signals external to the neural system, or signals generated by other neurons of the same neural system, or both. The input signal may be a current or a voltage, real-valued or complex-valued. The input signal may comprise a numerical value with a fixed-point or a floating-point representation. These input signals may be delivered to the neuron 202 through synaptic connections that scale the signals according to adjustable synaptic weights 206₁-206_{N} (w₁-w_{N}), where N may be a total number of input connections of the neuron 202.

The neuron 202 may combine the scaled input signals and use the combined scaled inputs to generate an output signal 208 (i.e., a signal y). The output signal 208 may be a current, or a voltage, real-valued or complex-valued. The output signal may comprise a numerical value with a fixed-point or a floating-point representation. The output signal 208 may be then transferred as an input signal to other neurons of the same neural system, or as an input signal to the same neuron 202, or as an output of the neural system.

The processing unit (neuron) 202 may be emulated by an electrical circuit, and its input and output connections may be emulated by wires with synaptic circuits. The processing unit 202, its input and output connections may also be emulated by a software code. The processing unit 202 may also be emulated by an electric circuit, whereas its input and output connections may be emulated by a software code. In an aspect, the processing unit 202 in the computational network may comprise an analog electrical circuit. In another aspect, the processing unit 202 may comprise a digital electrical circuit. In yet another aspect, the processing unit 202 may comprise a mixed-signal electrical circuit with both analog and digital components. The computational network may comprise processing units in any of the aforementioned forms. The computational network (neural system or neural network) using such processing units may be utilized in a large range of applications, such as image and pattern recognition, machine learning, motor control, and alike.

During the course of training of neural network, synaptic weights (e.g., the weights w₁^{(i,i+1)}, . . . , w_{P}^{(i,i+1)} from FIG. 1 and/or the weights 206₁-206_{N} from FIG. 2) may be initialized with random values and increased or decreased according to a learning rule. Some examples of the learning rule are the spike-timing-dependent plasticity (STDP) learning rule, the Hebb rule, the Oja rule, the Bienenstock-Copper-Munro (BCM) rule, etc. Very often, the weights may settle to one of two values (i.e., a bimodal distribution of weights). This effect can be utilized to reduce the number of bits per synaptic weight, increase the speed of reading and writing from/to a memory storing the synaptic weights, and to reduce power consumption of the synaptic memory.

### Synapse Type

In hardware and software models of neural networks, processing of synapse related functions can be based on synaptic type. Synapse types may comprise non-plastic synapses (no changes of weight and delay), plastic synapses (weight may change), structural delay plastic synapses (weight and delay may change), fully plastic synapses (weight, delay and connectivity may change), and variations thereupon (e.g., delay may change, but no change in weight or connectivity). The advantage of this is that processing can be subdivided. For example, non-plastic synapses may not require plasticity functions to be executed (or waiting for such functions to complete). Similarly, delay and weight plasticity may be subdivided into operations that may operate together or separately, in sequence or in parallel. Different types of synapses may have different lookup tables or formulas and parameters for each of the different plasticity types that apply. Thus, the methods would access the relevant tables for the synapse's type.

There are further implications of the fact that spike-timing dependent structural plasticity may be executed independently of synaptic plasticity. Structural plasticity may be executed even if there is no change to weight magnitude (e.g., if the weight has reached a minimum or maximum value, or it is not changed due to some other reason) since structural plasticity (i.e., an amount of delay change) may be a direct function of pre-post spike time difference. Alternatively, it may be set as a function of the weight change amount or based on conditions relating to bounds of the weights or weight changes. For example, a synapse delay may change only when a weight change occurs or if weights reach zero but not if they are maxed out. However, it can be advantageous to have independent functions so that these processes can be parallelized reducing the number and overlap of memory accesses.

### Neuron Models and Operation

There are some general principles for designing a useful spiking neuron model. A good neuron model may have rich potential behavior in terms of two computational regimes: coincidence detection and functional computation. Moreover, a good neuron model should have two elements to allow temporal coding: arrival time of inputs affects output time and coincidence detection can have a narrow time window. Finally, to be computationally attractive, a good neuron model may have a closed-form solution in continuous time and have stable behavior including near attractors and saddle points. In other words, a useful neuron model is one that is practical and that can be used to model rich, realistic and biologically-consistent behaviors, as well as be used to both engineer and reverse engineer neural circuits.

A neuron model may depend on events, such as an input arrival, output spike or other event whether internal or external. To achieve a rich behavioral repertoire, a state machine that can exhibit complex behaviors may be desired. If the occurrence of an event itself, separate from the input contribution (if any) can influence the state machine and constrain dynamics subsequent to the event, then the future state of the system is not only a function of a state and input, but rather a function of a state, event, and input.

In an aspect, a neuron n may be modeled as a spiking leaky-integrate-and-fire neuron with a membrane voltage vₙ(t) governed by the following dynamics,

$$\frac{d {v}_{n} ( t )}{d t} = α {v}_{n} ( t ) + β {\sum }_{m} {w}_{m , n} {y}_{m} ( t - Δ {t}_{m , n} ) , \qquad ( 1 )$$

where a and fi are parameters, w_{m,n}, is a synaptic weight for the synapse connecting a pre-synaptic neuron m to a post-synaptic neuron n, and yₘ(t) is the spiking output of the neuron m that may be delayed by dendritic or axonal delay according to Δt_{m,n} until arrival at the neuron n's soma.

It should be noted that there is a delay from the time when sufficient input to a post-synaptic neuron is established until the time when the post-synaptic neuron actually fires. In a dynamic spiking neuron model, such as Izhikevich's simple model, a time delay may be incurred if there is a difference between a depolarization threshold vₜ and a peak spike voltage vₚₑₐₖ. For example, in the simple model, neuron soma dynamics can be governed by the pair of differential equations for voltage and recovery, i.e.,

$$\begin{matrix}\frac{d v}{d t} = ( k ( v - {v}_{t} ) ( v - {v}_{r} ) - u + I ) / C , & ( 2 ) \\ \frac{d u}{d t} = a ( b ( v - {v}_{r} ) - u ) . & ( 3 )\end{matrix}$$

where v is a membrane potential, u is a membrane recovery variable, k is a parameter that describes time scale of the membrane potential v, a is a parameter that describes time scale of the recovery variable u, b is a parameter that describes sensitivity of the recovery variable u to the sub-threshold fluctuations of the membrane potential v, vᵣ is a membrane resting potential, I is a synaptic current, and C is a membrane's capacitance. In accordance with this model, the neuron is defined to spike when v>vₚₑₐₖ.

### Hunzinger Cold Model

The Hunzinger Cold neuron model is a minimal dual-regime spiking linear dynamical model that can reproduce a rich variety of neural behaviors. The model's one- or two-dimensional linear dynamics can have two regimes, wherein the time constant (and coupling) can depend on the regime. In the sub-threshold regime, the time constant, negative by convention, represents leaky channel dynamics generally acting to return a cell to rest in biologically-consistent linear fashion. The time constant in the supra-threshold regime, positive by convention, reflects anti-leaky channel dynamics generally driving a cell to spike while incurring latency in spike-generation.

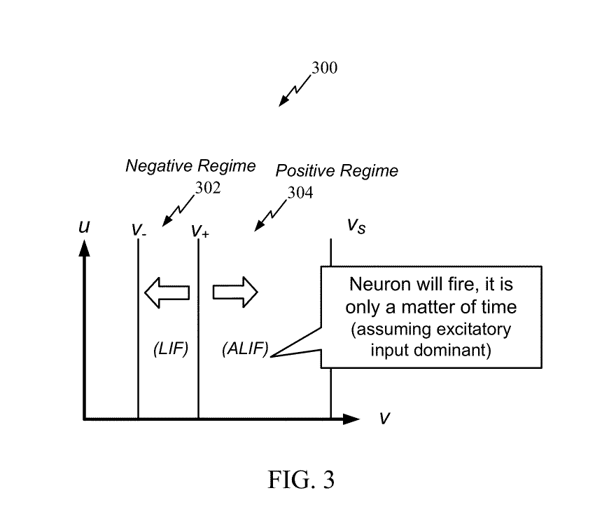

As illustrated in FIG. 3, the dynamics of the model may be divided into two (or more) regimes. These regimes may be called the negative regime 302 (also interchangeably referred to as the leaky-integrate-and-fire (LIF) regime, not to be confused with the LIF neuron model) and the positive regime 304 (also interchangeably referred to as the anti-leaky-integrate-and-fire (ALIF) regime, not to be confused with the ALIF neuron model). In the negative regime 302, the state tends toward rest (v₋) at the time of a future event. In this negative regime, the model generally exhibits temporal input detection properties and other sub-threshold behavior. In the positive regime 304, the state tends toward a spiking event (vₛ). In this positive regime, the model exhibits computational properties, such as incurring a latency to spike depending on subsequent input events. Formulation of dynamics in terms of events and separation of the dynamics into these two regimes are fundamental characteristics of the model.

Linear dual-regime bi-dimensional dynamics (for states v and u) may be defined by convention as,

$$\begin{matrix}{τ}_{ρ} \frac{d v}{d t} = v + {q}_{ρ} & ( 4 ) \\ - {τ}_{u} \frac{du}{dt } = u + r & ( 5 )\end{matrix}$$

where q_{q} and r are the linear transformation variables for coupling.

The symbol ρ is used herein to denote the dynamics regime with the convention to replace the symbol ρ with the sign “−” or “+” for the negative and positive regimes, respectively, when discussing or expressing a relation for a specific regime.

The model state is defined by a membrane potential (voltage) v and recovery current u. In basic form, the regime is essentially determined by the model state. There are subtle, but important aspects of the precise and general definition, but for the moment, consider the model to be in the positive regime 304 if the voltage v is above a threshold (v₊) and otherwise in the negative regime 302.

The regime-dependent time constants include τ₋ which is the negative regime time constant, and τ₊ which is the positive regime time constant. The recovery current time constant τᵤ is typically independent of regime. For convenience, the negative regime time constant τ₋ is typically specified as a negative quantity to reflect decay so that the same expression for voltage evolution may be used as for the positive regime in which the exponent and τ₊ will generally be positive, as will be τᵤ.

The dynamics of the two state elements may be coupled at events by transformations offsetting the states from their null-clines, where the transformation variables are

q_{ρ}=−τ_{ρ}βu−v_{ρ} (6)

r=δ(v+ε) (7)

where δ, ε, β and v₋, v₊ are parameters. The two values for v_{ρ} are the base for reference voltages for the two regimes. The parameter v₋ is the base voltage for the negative regime, and the membrane potential will generally decay toward v₋ in the negative regime. The parameter v₊ is the base voltage for the positive regime, and the membrane potential will generally tend away from v₊ in the positive regime.

The null-clines for v and u are given by the negative of the transformation variables q_{ρ} and r, respectively. The parameter δ is a scale factor controlling the slope of the u null-cline. The parameter ε is typically set equal to −v₋. The parameter β is a resistance value controlling the slope of the v null-clines in both regimes. The τ_{ρ} time-constant parameters control not only the exponential decays, but also the null-cline slopes in each regime separately.

The model is defined to spike when the voltage v reaches a value vₛ. Subsequently, the state is typically reset at a reset event (which technically may be one and the same as the spike event):

v=\hat{v}₋ (8)

u=u+Δu (9)

where \hat{v}₋ and Δu are parameters. The reset voltage \hat{v}₋ is typically set to v₋.

By a principle of momentary coupling, a closed form solution is possible not only for state (and with a single exponential term), but also for the time required to reach a particular state. The close form state solutions are

$$\begin{matrix}v ( t + Δ t ) = {( v ( t ) + {q}_{ρ} )}^{{e}^{\frac{Δ t}{{τ}_{ρ}}}} - {q}_{ρ} & ( 10 ) \\ u ( t + Δ t ) = ( u ( t ) + r ) {e}^{\frac{Δ t}{{τ}_{u}}} - r & ( 11 )\end{matrix}$$

Therefore, the model state may be updated only upon events such as upon an input (pre-synaptic spike) or output (post-synaptic spike). Operations may also be performed at any particular time (whether or not there is input or output).

Moreover, by the momentary coupling principle, the time of a post-synaptic spike may be anticipated so the time to reach a particular state may be determined in advance without iterative techniques or Numerical Methods (e.g., the Euler numerical method). Given a prior voltage state v₀, the time delay until voltage state v_{f} is reached is given by

$$Δ t = {τ}_{ρ} log \frac{{v}_{f} + {q}_{ρ}}{{v}_{0} + {q}_{ρ}} \qquad ( 12 )$$

If a spike is defined as occurring at the time the voltage state v reaches vₛ, then the closed-form solution for the amount of time, or relative delay, until a spike occurs as measured from the time that the voltage is at a given state v is

$$Δ {t}_{s} = \{ \begin{matrix}{τ}_{+} log \frac{{v}_{s} + {q}_{+}}{v + {q}_{+}} & if v > {\hat{v}}_{+} \\ ∞ & otherwise\end{matrix} \qquad ( 13 )$$

where \hat{v}₊ is typically set to parameter v₊, although other variations may be possible.

The above definitions of the model dynamics depend on whether the model is in the positive or negative regime. As mentioned, the coupling and the regime ρ may be computed upon events. For purposes of state propagation, the regime and coupling (transformation) variables may be defined based on the state at the time of the last (prior) event. For purposes of subsequently anticipating spike output time, the regime and coupling variable may be defined based on the state at the time of the next (current) event.

There are several possible implementations of the Cold model, and executing the simulation, emulation or model in time. This includes, for example, event-update, step-event update, and step-update modes. An event update is an update where states are updated based on events or “event update” (at particular moments). A step update is an update when the model is updated at intervals (e.g., 1 ms). This does not necessarily require iterative methods or Numerical methods. An event-based implementation is also possible at a limited time resolution in a step-based simulator by only updating the model if an event occurs at or between steps or by “step-event” update.

### Neural Coding

A useful neural network model, such as one comprised of the artificial neurons 102, 106 of FIG. 1, may encode information via any of various suitable neural coding schemes, such as coincidence coding, temporal coding or rate coding. In coincidence coding, information is encoded in the coincidence (or temporal proximity) of action potentials (spiking activity) of a neuron population. In temporal coding, a neuron encodes information through the precise timing of action potentials (i.e., spikes) whether in absolute time or relative time. Information may thus be encoded in the relative timing of spikes among a population of neurons. In contrast, rate coding involves coding the neural information in the firing rate or population firing rate.

If a neuron model can perform temporal coding, then it can also perform rate coding (since rate is just a function of timing or inter-spike intervals). To provide for temporal coding, a good neuron model should have two elements: (1) arrival time of inputs affects output time; and (2) coincidence detection can have a narrow time window. Connection delays provide one means to expand coincidence detection to temporal pattern decoding because by appropriately delaying elements of a temporal pattern, the elements may be brought into timing coincidence.

Arrival Time

In a good neuron model, the time of arrival of an input should have an effect on the time of output. A synaptic input—whether a Dirac delta function or a shaped post-synaptic potential (PSP), whether excitatory (EPSP) or inhibitory (IPSP)—has a time of arrival (e.g., the time of the delta function or the start or peak of a step or other input function), which may be referred to as the input time. A neuron output (i.e., a spike) has a time of occurrence (wherever it is measured, e.g., at the soma, at a point along the axon, or at an end of the axon), which may be referred to as the output time. That output time may be the time of the peak of the spike, the start of the spike, or any other time in relation to the output waveform. The overarching principle is that the output time depends on the input time.

One might at first glance think that all neuron models conform to this principle, but this is generally not true. For example, rate-based models do not have this feature. Many spiking models also do not generally conform. A leaky-integrate-and-fire (LIF) model does not fire any faster if there are extra inputs (beyond threshold). Moreover, models that might conform if modeled at very high timing resolution often will not conform when timing resolution is limited, such as to 1 ms steps.

Inputs

An input to a neuron model may include Dirac delta functions, such as inputs as currents, or conductance-based inputs. In the latter case, the contribution to a neuron state may be continuous or state-dependent.

### Overview

Certain aspects of the present disclosure support a sequence of design procedures for emergent multi-layer spiking networks, namely feature detection (i.e., emergent visual cortex feature detection) and saliency detection (i.e., emergent popout). Moreover, these procedures may be automated or partially-automated, for example via an interactive generic design environment wizard. Such an automated design process may comprise interactively obtaining design parameters, executing design steps conveying intermediary results and evaluating performance results in terms of provided objectives. In an aspect, the design procedures may comprise designing one layer at a time, beginning with a lowest level layer, i.e., the layer nearest to an input. While the design procedures are demonstrated for a spiking visual system including magno and parvo pathways, these procedures are generic and can be applied to generic design problems.

In designing a spiking network, one aims to achieve a set of objectives such as feature detection or saliency detection. Feature detection generally refers to the operation of detecting a diversity of features in input stimuli. The input characteristics that a particular cell or cells respond to or is sensitive to for feature detection is typically referred to as the receptive field. For example, feature detection may refer to detection of simple visual patterns by retinal ganglion cells having center-surround receptive fields. Another example can refer to visual simple cells that may detect oriented bars because of a receptive field composed of a combination of retinal ganglion cell receptive fields. Saliency detection generally refers to the operation of detecting salient features, i.e., the subset of features that are salient, striking, noticeable or otherwise outstanding for a particular reason or reasons. For example, a single horizontally oriented bar may be particularly salient among vertically oriented bars. The term “popout” is often referred to the prominent awareness of such salient features. The saliency may be detected based on feature detection by detecting unique features or, equivalently, suppressing common features. For example, if simple cells with a particular orientation inhibit (suppress) simple cells with the same orientation but in different locations, their common response may be suppressed. However, if a single simple cell with another orientation responds, it is not suppressed and thus “pops-out”.

In the context of a spiking neural network, information may be encoded in spikes. The problem is to design such a spiking neural network that can learn to extract (respond to) useful features in the observed input spikes with output spikes. The present disclosure provides a solution to this. The emphasis herein is on the network learning how spikes should encode information. The solution framework may comprise: (1) means to calculate a plausible set of parameters for neurons that are designed, for example, with the Hunzinger Cold neuron model; (2) means to design synaptic plasticity rules; (3) means to design network topology; and (4) means to determine synaptic delays and weights (or ranges and related parameters); and (5) means to balance interaction between saliency detection and feature detection. The solution involves determining a suitable combination of timing parameters and timing-related aspects to match time-dependent learning with input/output times of input/output aspects to be learned or associated.

Regarding the latter, the present disclosure comprises embodiments that are capable of creating a saliency detection network that can function in parallel to feature detection. It will become apparent that these two features in a spiking neural network can potentially work against one another but countermeasures can prevent this.

### Emergent Feature Detection

Certain aspects of the present disclosure support a design process that can be used to determine parameters or parameter ranges for achieving desired feature detection in a particular layer of a multi-layer spiking neural network, wherein pre-determined input signals may be applied to the neural network. In an aspect, the parameters and parameter ranges may be determined utilizing logical approach and parameter searches including a constrained parameter search, wherein the “logical approach” can be used to constrain the parameter search. The feature detection can be achieved, for example, by a feed-forward excitatory connectivity with local lateral inhibition. The local lateral inhibition does not necessarily need inhibitory cells because recurrent inhibitory connections in the excitatory cell layer may be utilized, thus reducing requirements on number of units.

Excitation generally refers to a positive impact on receiving cell's voltage or spiking, i.e., contributing toward spiking. Inhibition generally refers to a negative impact on receiving cell's voltage or spiking, i.e., contributing to suppressing or preventing spiking. In biology, inhibition is typically applied to a post-synaptic neuron by inhibitor inter-neurons via inhibitory neurotransmitters as opposed to excitatory neurotransmitters. However, in a computer model, there is no strict requirement that neurons have only one type of connection and thus models may often be compressed by having a cell with both excitatory and inhibitory outputs, rather than an output to an intermediary that has the opposite type of output.

### Unit Model Selection

In an aspect of the present disclosure, a neural model design may be selected with desired control elements and features. For example, the design procedure may adjust one or more time constants of the unit model individually, and thus it may be facilitated by a neural model (such as the Hunzinger Cold neural model) with such controls. Regarding features, a neural model may not need to be configured to utilize all available features. For example, if there is no need for resonance or there is a limited requirement for memory across spikes (inter-spike) (e.g., across input frames), then a two dimensional model may not be needed. In an aspect, a one-dimensional Hunzinger Cold neural model can be obtained by setting one of its parameters (e.g., the parameter β in the aforementioned Hunzinger Cold model) to a low value or zero.

The resonance refers to a sub-threshold or super-threshold oscillatory behavior. For example, a cell's membrane potential may oscillate below a threshold or a cell may spike or burst at a particular frequency or frequencies. The resonance may be useful for synchronization or other timing-related functional aspects of neuron behavior or neural network behavior. In an aspect, a cell may retain “memory” of prior activity in the resonant state. For example, if a cell resonates at a particular frequency, it effectively maintains memory of the time offset (or modulo time) from a particular oscillation event (e.g., peak or prior stimulation).

### Architectural Template

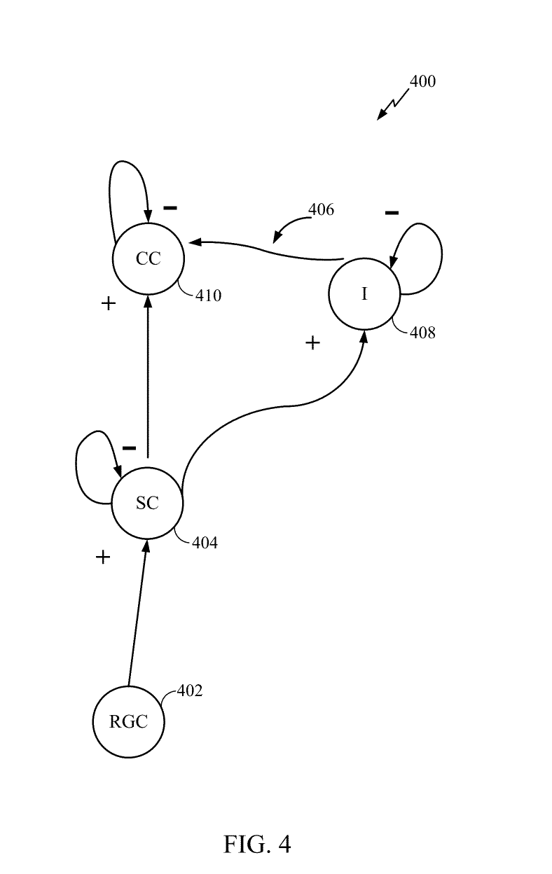

FIG. 4 illustrates an example architectural network template 400 of a multi-layer neural network in accordance with certain aspects of the present disclosure. FIG. 4 describes the basic arrangement that may produce desired results. This network template may provide the basic requirement for emergence of neurons for feature detection, i.e., feed-forward excitation and lateral inhibition.

Feed-forward excitation typically refers to a prior layer exciting a subsequent layer with a particular feed-forward connectivity pattern. Such arrangements can be useful for utilizing the subsequent layer as a detector array for patterns in the activity of the prior layer. Different elements (cells) in the subsequent layer may become active when particular patterns of activity occur in the prior layer (e.g., location and timing firing patterns). Lateral connectivity refers to connectivity between elements in the same layer, and local connectivity refers to connectivity between physically proximate elements. Thus, local lateral connectivity refers to connectivity between physically proximate elements in the same layer. Local lateral inhibition is useful for suppressing redundant responses, such as the response to learning features of a prior layer's activity from feed-forward connectivity.

As illustrated in FIG. 4, the network 400 may comprise an input layer 402 of Retinal Ganglion Cell (RGC) neuron circuits with non-plastic synapses. The input layer of RGC neurons 402 may be connected to a first layer of neuron circuits 404 (e.g., Superior Colliculus (SC) neurons) associated with plastic synapses. The layer of neuron circuits 404 may be connected with a second layer of neuron circuits 406 that may comprise two Cold neuron types, i.e., neurons of an inhibitory sub-layer 408 and neurons of an excitatory sub-layer 410.

In implementing the first layer of neuron circuits 404 and the second layer of neuron circuits 406, certain considerations should be taken into account. First, developing of macro structures (pinwheels) during the implementation process may occur. However, they may be undesirable for low density/small visual cortex cells. It should be noted that the pinwheels may produce uniformity at a high level, but not locally. Second, a limited number of units for task (test) may be available.

Pinwheels refer to organization of orientation selective cells, specifically when visualized in color where color reflects orientation, in the shape of color pinwheels. However, by definition, this organization has local structure that may not be uniform (such as clustering of like orientation cells) when viewed at high resolution (or locally) and yet create uniformity at a lower resolution (more global scale). A computer model may have limited elements and have varying purposes. If uniformity is desired for the purposes of the model (such as regularized feature detection across a large visual field), then macro structure such as pinwheels may be undesirable except at a low resolution (global) such that the pinwheel structures are small relative to the field size. Thus, the field may appear uniform at the resolution afforded by the limited number of elements.

Certain aspects of the present disclosure support a specific approach for implementing the first layer of neuron circuits 404 and the second layer of neuron circuits 406 from FIG. 4. For example, the implementation design may be suited for uniformity, e.g., by adjusting lateral inhibition. In addition, certain orientations may be targeted for use. For example, horizontal and vertical features may be achieved using gratings.

Gratings are often used in training of visual systems. Gratings may be considered as sinusoidal contrast or color wave patterns oriented in a particular direction in two dimensions. The gratings are often moved at a particular velocity across the visual field for training. To train a system for feature detection of features with particular orientations (e.g., oriented bars), it may be needed only to show the system gratings with those particular orientations. For example, in order to train a system with a roughly uniform density of feature detectors across the visual field, one may also desire uniformity of training media or gratings. Lateral inhibition may be used to control the level and extent of redundancy of the developing feature detectors for each orientation.

### Estimation of Input Rate

To estimate the input activity, an average inter-event-interval τᵢ₋₁ (i.e., interval between two consecutive spiking events associated with a neuron) in layer i−1 across all neurons in that layer may need first to be calculated. Then, a total number of neurons Nᵢ₋₁ in the layer i−1 may need to be determined, where the layer i−1 represents an input for a layer i. After that, an average fan-in degree nᵢ may be calculated across all neurons in the layer i (nᵢ is also an average number of pre-synaptic neurons in the layer i).

The ratio between the average fan-in degree of layer i and the total number of neurons in layer i−1, nᵢ/Nᵢ₋₁, may provide an estimate of the expected number of spikes impinging on the recipient neuron or victim neuron. This estimate assumes little or no lateral input. The activity level, i.e., an input rate for a neuron in layer i, λᵢ may be estimated as,

$${λ}_{i} = \frac{{n}_{i}}{{N}_{i - 1} \cdot {τ}_{i - 1}} . \qquad ( 14 )$$

### Determination of Time Constants

In an aspect of the present disclosure, an amount of time it takes for a post-synaptic neuron to detect a signal may be estimated, given the estimated input rate λᵢ. Without loss of generality, it can be assumed that x spikes may be needed to trigger the post-synaptic neuron to cross a threshold (in the Hunzinger Cold model v>v₊) and sometime thereafter fire. In the case of Poisson distribution for the probability of a post-synaptic neuron spiking P(k=x; λᵢ) in layer i, a Complementary Cumulative Distribution Function (CCDF) may be given as,

$$CCDF ( k \geq x ; {λ}_{i} ) = 1 - {e}^{- {λ}_{i} t} {\sum }_{j = 0}^{\vert x - {1}_{-} \vert} {( {λ}_{i} t )}^{j} . \qquad ( 15 )$$

Equation (15) may be solved for t, assuming P(k=x; λᵢ)=η=50%, i.e., assuming 50% confidence to have x or more spikes in time t given the rate λᵢ. Poisson distribution is only an example, used for simplicity of demonstration and because biological spiking inter-spike intervals are often modeled as exponentially distributed.

In an aspect of the present disclosure, the detection time constant τ₋ of the aforementioned Hunzinger Cold model may be determined. In general, this constant refers to the timing characteristics of leaky aspects of the neuron model. Such behavior may only occur in a particular regime, which can be referred to as the leaky-integrative region as, for example, in a simple leaky-integrate-and-fire (LIF) neuron model. In the Hunzinger Cold model, this region is called the negative regime, and the time constant in that regime controls the leakiness of the integration below threshold. For example, τ₋ can be calculated based on the 50% decay over the time interval t to obtain x spikes with 90% confidence given the rate λᵢ, i.e.,

$${τ}_{-} = \frac{t}{ln ( 2 )} . \qquad ( 16 )$$

In order to determine the time constant τ₊ of the aforementioned COLD model (i.e., anti-leaky-integrate-and-fire (ALIF) time constant), the probability of a spike from a local neighboring neuron may need to be considered. In an aspect, events from lateral connections can be used to determine the ALIF time constant because lateral contributions reflect control of redundancy or overlap via either inhibition or excitation. If the cell spikes before there is a time for this input to propagate from the same layer, that input would be superfluous. A similar estimation process as for τ₋ may be utilized for estimating τ₊. For a neuron in layer I, the CDF(k=x; ξᵢ) can be considered, where ξᵢ is the expected event rate from the lateral connections. In an aspect, it may be possible to stipulate in the τ₊ that one would only allow for at most on average one local inhibitory spike to disrupt the neuron up-stroke with a probability of y, and the CDF can be computed for Poisson distribution as,

CDF(k=x=1; ξᵢ)=e^{-λ}^{ᵢ}^{t}(1+λᵢt)=y. (17)

This is possible because the probability of a local inhibitory spike being able to disrupt/block a neuron's firing depends on the timing from sufficient depolarization and on the time of the disrupting inhibitory input or on the amount of increase in the membrane potential over that time. Modeling inputs as independent events is one example to make the computation tractable.

Once equation (17) is solved for t, τ₊ can be determined by computing,

$${τ}_{+} = \frac{t}{ln ( {v}_{peak} - {v}_{+} )} . \qquad ( 18 )$$

### Determination of Initial and Maximum Weight Value

In an aspect of the present disclosure, a current-based synaptic input may be modeled as a direct delta offset in voltage in the unit model. Such an input refers to a current input, a value that is typically multiplied by a constant to convert a current into a voltage offset. A certain amount of input may bring the model state from rest into a state where it will eventually spike even without further input. With a straightforward Hunzinger Cold neural model, the amount of voltage change Δv₋ may be needed to bring a cell at rest v=v₋ into the spiking regime v>v₊, where voltage will increase toward spike rather than decrease toward rest.

Given the difference Δv₋=v₊−v₋, the initial weight needed for response wᵢₙᵢₜ can be estimated as,

$${w}_{init} \geq \frac{Δ {v}_{-}}{E [ {n}_{i} ]} , \qquad ( 19 )$$

where E[nᵢ] is expected number of spikes from all pre-synaptic neurons per frame of inputs that occur at a given time.

In an aspect of the present disclosure, the maximum weight should be set larger than wᵢₙᵢₜ defined by equation (19). For example, the maximum weight value may be set to approximately a double of the initial weight. However, setting that is more precise may be determined by computing the fraction of fan-in inputs that would contribute to eventual firing, and multiplying the initial weight by that number to obtain the maximum synaptic weight.

### Determination of Synaptic Plasticity

Neuroplasticity (or simply “plasticity”) is the capacity of neurons and neural networks in the brain to change their synaptic connections and behavior in response to new information, sensory stimulation, development, damage, or dysfunction. Plasticity is important to learning and memory in biology, as well as for computational neuroscience and neural networks. Various forms of plasticity have been studied, such as synaptic plasticity (e.g., according to the Hebbian theory), spike-timing-dependent plasticity (STDP), non-synaptic plasticity, activity-dependent plasticity, structural plasticity and homeostatic plasticity.

STDP is a learning process that adjusts the strength of synaptic connections between neurons. The connection strengths are adjusted based on the relative timing of a particular neuron's output and received input spikes (i.e., action potentials). Under the STDP process, long-term potentiation (LTP) may occur if an input spike to a certain neuron tends, on average, to occur immediately before that neuron's output spike. Then, that particular input is made somewhat stronger. On the other hand, long-term depression (LTD) may occur if an input spike tends, on average, to occur immediately after an output spike. Then, that particular input is made somewhat weaker, and hence the name “spike-timing-dependent plasticity”. Consequently, inputs that might be the cause of the post-synaptic neuron's excitation are made even more likely to contribute in the future, whereas inputs that are not the cause of the post-synaptic spike are made less likely to contribute in the future. The process continues until a subset of the initial set of connections remains, while the influence of all others is reduced to zero or near zero.

Since a neuron generally produces an output spike when many of its inputs occur within a brief period, i.e., being cumulative sufficient to cause the output, the subset of inputs that typically remains includes those that tended to be correlated in time. In addition, since the inputs that occur before the output spike are strengthened, the inputs that provide the earliest sufficiently cumulative indication of correlation will eventually become the final input to the neuron.

The STDP learning rule may effectively adapt a synaptic weight of a synapse connecting a pre-synaptic neuron to a post-synaptic neuron as a function of time difference between spike time tₚᵣₑ of the pre-synaptic neuron and spike time tₚₒₛₜ of the post-synaptic neuron (i.e., t=tₚₒₛₜ−tₚᵣₑ). A typical formulation of the STDP is to increase the synaptic weight (i.e., potentiate the synapse) if the time difference is positive (the pre-synaptic neuron fires before the post-synaptic neuron), and decrease the synaptic weight (i.e., depress the synapse) if the time difference is negative (the post-synaptic neuron fires before the pre-synaptic neuron).

In the STDP, a change of the synaptic weight over time may be typically achieved using an exponential decay, as given by,

$$Δ w ( t ) = \{ \begin{matrix}{a}_{+} {e}^{- t / {k}_{+}} + μ , & t > 0 \\ {a}_{-} {e}^{t / {k}_{-}} , & t < 0 ,\end{matrix} \qquad ( 20 )$$

where k₊ and k₋ are time constants for positive and negative time difference, respectively, a₊ and a₋ are corresponding scaling magnitudes, and μ is an offset that may be applied to the positive time difference and/or the negative time difference.

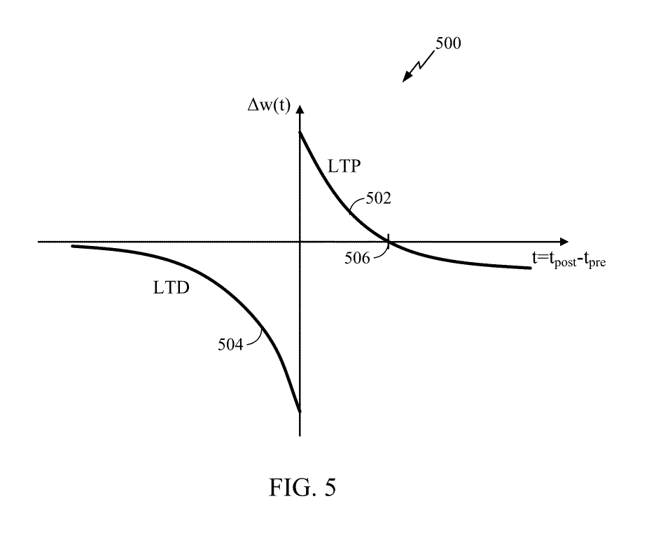

FIG. 5 illustrates an example graph diagram 500 of a synaptic weight change as a function of relative timing of pre-synaptic and post-synaptic spikes in accordance with the STDP. If a pre-synaptic neuron fires before a post-synaptic neuron, then a corresponding synaptic weight may be increased, as illustrated in a portion 502 of the graph 500. This weight increase can be referred to as an LTP of the synapse. It can be observed from the graph portion 502 that the amount of LTP may decrease roughly exponentially as a function of the difference between pre-synaptic and post-synaptic spike times. The reverse order of firing may reduce the synaptic weight, as illustrated in a portion 504 of the graph 500, causing an LTD of the synapse.

As illustrated in the graph 500 in FIG. 5, a negative offset μ may be applied to the LTP (causal) portion 502 of the STDP graph. A point of cross-over 506 of the x-axis (y=0) may be configured to coincide with the maximum time lag for considering correlation for causal inputs from layer i−1. In the case of a frame-based input (i.e., an input is in the form of a frame of a particular duration comprising spikes or pulses), the offset value μ can be computed to reflect the frame boundary. A first input spike (pulse) in the frame may be considered to decay over time either as modeled by a post-synaptic potential directly or in terms of the effect on neural state. If a second input spike (pulse) in the frame is considered correlated or relevant of a particular time frame, then the relevant times before and after the frame may be separated at that time frame boundary and treated differently in plasticity terms by offsetting one or more parts of the STDP curve such that the value in the relevant times may be different (e.g., negative for greater than one frame and positive for less than one frame). For example, the negative offset μ may be set to offset LTP such that the curve actually goes below zero at a pre-post time greater than the frame time and it is thus part of LTD instead of LTP.

### Emergent Saliency Detection

Certain aspects of the present disclosure support a design process that can be utilized to determine parameters or parameter ranges for achieving reasonable saliency detection (popout) in a multi-layer spiking neural network. For example, the saliency detection can be achieved by suppressing responses of feature detector cells (excitatory neurons) using feature-selective long-range inhibition cells (inhibitory neurons) that fire in advance of excitatory cells in the same layer. There are two feature detection sub-layers each developed as per above—excitatory and inhibitory sub-layers, named so because of the intended effect of their output. Specifically, the inhibitory sub-layer can provide long-range inhibition via fan-out to the excitatory cells, wherein the inhibition is in addition to the local inhibitory connections within each sub-layer. The sub-layers can be designed according to the principles outlined above.

Emergence refers to the development of feature detection or saliency or both. Important consideration for the emergence is designing the training paradigm. One may use a staged training scheme, in which each layer or module is emerged separately and sequentially. Some layers may be trained in parallel within a given stage, particularly if they are not interdependent at that training stage. This approach may utilize training images that occupy the entire or large area of the visual field. On the other hand, one may use a simultaneous training scheme, in which all plastic synapses co-emerge concurrently. To accomplish the same objective, one may design the training images so that information emerges from a local scale to global scale. Such training may take an iterative approach, whereby connections are trained for one or more independent parts of a network and then annealed (frozen) before training connections for dependent parts or interdependent parts. The training may proceed hierarchically.

### Sub-Layer Design Considerations

After selecting a neuron model designed with desired control elements and features as previously described, the subsequent design elements for the saliency detection sub-layer may need to be considered. Because the emergent long-range inhibition may conflict with the emergent feature detection process in the excitatory sub-layer, it may be useful that the training for feature detection precedes the training process for saliency (long-range inhibition). In an aspect, feature detection may need to re-checked later after the saliency emergence.

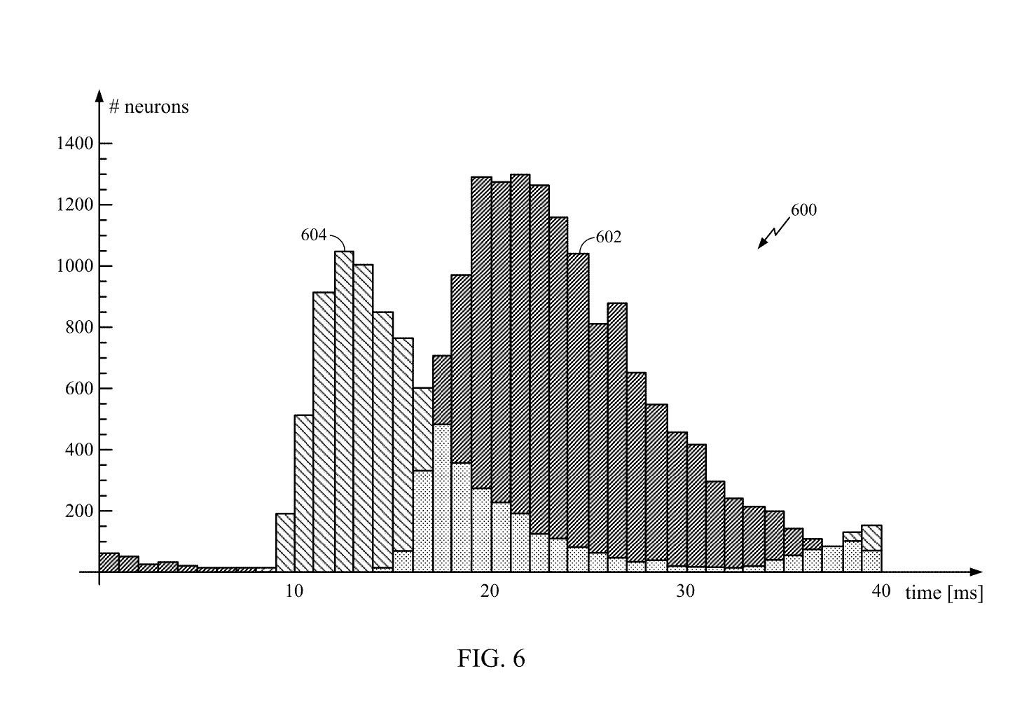

Furthermore, excitatory cell neuron parameters may need to be determined in such a way that there is sufficient activity as exhibited in histograms 600 in FIG. 6 (see, for example, a histogram 602 in FIG. 6). FIG. 6 illustrates the histograms 602 and 604 of timing of spiking of an excitatory sub-layer without inhibition (histogram 602) and of spiking of an inhibitory sub-layer (histogram 604) relative with respect to each other in accordance with certain aspects of the present disclosure.

The activity of the excitatory sub-layer (layer to be suppressed) without the long-range activity (suppression) should be large, as being illustrated in FIG. 6 where spiking of long-range inhibition (histogram 604) is suppressed relative to spiking of the excitatory sub-layer (histogram 602). To achieve this, a number of spikes in post-synaptic neurons Sₚₒₛₜ may need to be larger than a number of spikes in pre-synaptic neurons Sₚᵣₑ, wherein post- and pre-refer to excitatory sub-layer and inhibitory sub-layer cells respectively in the context of long-range connectivity from neurons in the inhibitory sub-layer to neurons in the excitatory sub-layer, i.e.,

$$\frac{{S}_{post}}{{S}_{pre}} > 1. \qquad ( 21 )$$

In an aspect of the present disclosure, excitatory cell neuron parameters and inhibitory (long-range) cell neuron parameters may need to be designed in such a way that inhibitory sub-layer cells are faster and fire a pre-determined amount of time in advance of excitatory cells. An example of this is illustrated by histograms 602 and 604 in FIG. 6 (relative timings of excitatory and inhibitory sub-layers, respectively). In an aspect, timings may be controlled using, for example, neuron model time constants and delays. Both excitatory and inhibitory sub-layers may be designed to be selective, distributed and uniform, i.e., spiking of neurons in the excitatory and inhibitory sub-layers may be selective, distributed and uniform.

There are a few options in achieving the aforementioned objectives for excitatory and inhibitory sub-layers. One option can be to modify τ₊ for excitatory sub-layer neurons so they will spike more slowly than inhibitory sub-layer neurons. Another option can be to modify synaptic delay δ from an input layer of a neural network to an excitatory sub-layer, so that the spikes will reach the excitatory sub-layer more slowly than the inhibitory sub-layer, wherein a synaptic delay represents a time period needed to convey a spike through a synapse connecting a pre-synaptic neuron and a post-synaptic neuron.

### Architectural Template for Long-Range Inhibitory Emergence

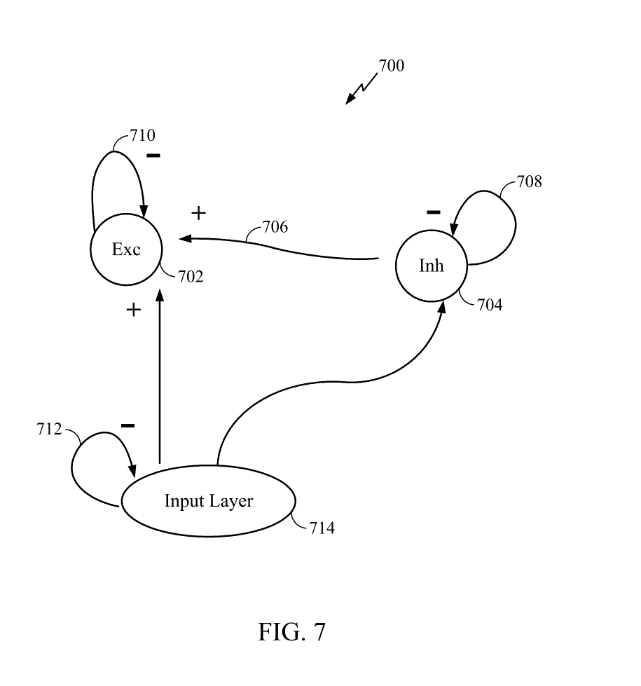

FIG. 7 illustrates an example architectural template 700 for long-range inhibitory emergence. This particular architecture may enable simultaneous emergence of feature detection in both excitatory sub-layer 702 and inhibitory sub-layer 704. This is because parts of a neural network that emerge may be mutually independent. Subsequently, the long-range lateral inhibition 706 for saliency can co-emerge. It should be noted that, for this particular embodiment, synapses 708, 710 and 712 are non-plastic.

In an aspect of the present disclosure, approximately the same number of neurons of an input layer 714 may be connected to each neuron of the excitatory sub-layer 702 and to each neuron of the inhibitory sub-layer 704. For example, 34 neurons of the input layer 714 may be connected to each excitatory neuron, and 34 neurons of the input layer 714 (same or different neurons from neurons of the input layer connected to the excitatory neuron) may be connected to each inhibitory neuron.

### Long-Range Inhibitory Emergence

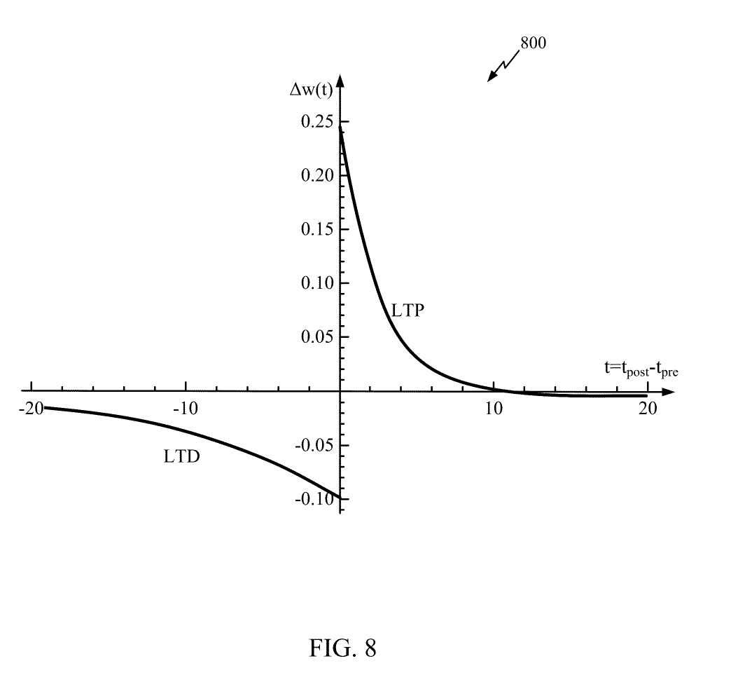

As aforementioned, the inhibitory neurons may be deliberately designed to spike ahead of the excitatory neurons given the same input. To make use of this arrangement for the emergence of long-range inhibitory synapse, one may need to co-design an STDP curve. First, the STDP curve can be co-designed to coincide with the timing difference described above, as illustrated by a graph 800 in FIG. 8.

A typical LTP curve is an exponentially decaying curve as the difference between pre-synaptic and post-synaptic spike times increases. That curve is typically applicable for causal times (i.e., the right hand side of FIG. 8 where the time difference between post and pre is positive or post is after pre). However, by offsetting this curve by a negative DC amount, the causal part of the STDP curve is no longer entirely positive. For example, in FIG. 8, the right-hand side of the STDP curve starts above the x-axis at t=0 but crosses the x-axis at around 10 ms. Thus, we have LTP for time differences shorter than 10 ms but LTD for time differences greater than 10 ms.

Subsequently, one may need to determine effect of the emergent long-range inhibitory connections on a network behavior. A long-range fan-out (i.e., synaptic connections) from inhibitory sub-layer cells to excitatory sub-layer cells can take the shape of an annulus, i.e., no local or weak local connections and strong long-range connections, which can be beneficial for saliency emergence.

### Discussion on Emergent Saliency

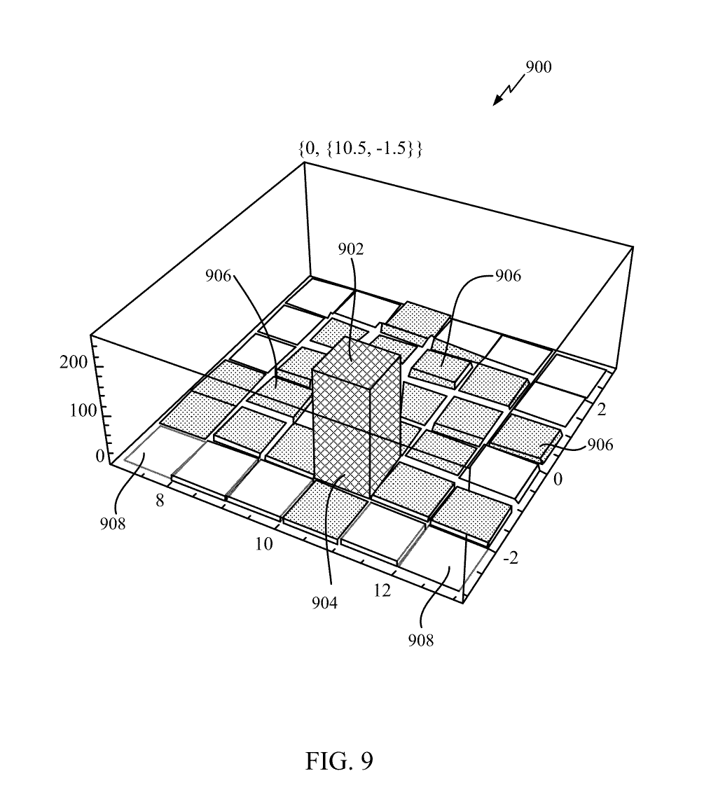

The popout effect described in working embodiments of the present disclosure represents a form of bottom-up of saliency. The bottom-up saliency refers to saliency that is derived from the feature detection output itself as opposed to high-level processing that determines lower level elements or components of a higher level feature are salient. While there are many ways to implement a popout system, the present embodiment focuses on examining behavior at the output of the excitatory neurons, i.e., in this embodiment, the emergence of popout can be observed in the output of the excitatory neurons. FIG. 9 illustrates an example of a desirable output from a layer 900 in accordance with certain aspects of the present disclosure. A bar 902 represents the cumulative spiking activity (for multiple neurons over period of time) of the feature-matched neurons in a popout region 904, i.e., True Positives (TP). In an aspect of the present disclosure, the cumulative spiking activity may need to be threshold to determine if that particular spiking activity represents TP. Surrounding colored squares 906 in FIG. 9 represent cumulative activities for two types of distractors in a popout, i.e., True Negatives (TN) and False Positives (FP). TN is defined as the response of a distractor neuron in regions 908 outside of the popout area 904. FP is defined as the response of a feature-matched neuron in regions 908 outside of the popout area 904.

It should be noted that, in the visual field, both excitatory and inhibitory neurons may be highly orientation tuned and uniformly distributed spatially. Since TP should have on-target activity indicating a correct (desired) feature, this aspect should be considered in designing the excitatory sub-layer. On the other hand, TN should have activity at non-target location indicating a distractor feature, and this aspect should be considered in designing the inhibitory sub-layer. Furthermore, a low level of FP should be present in the inhibitory sub-layer.

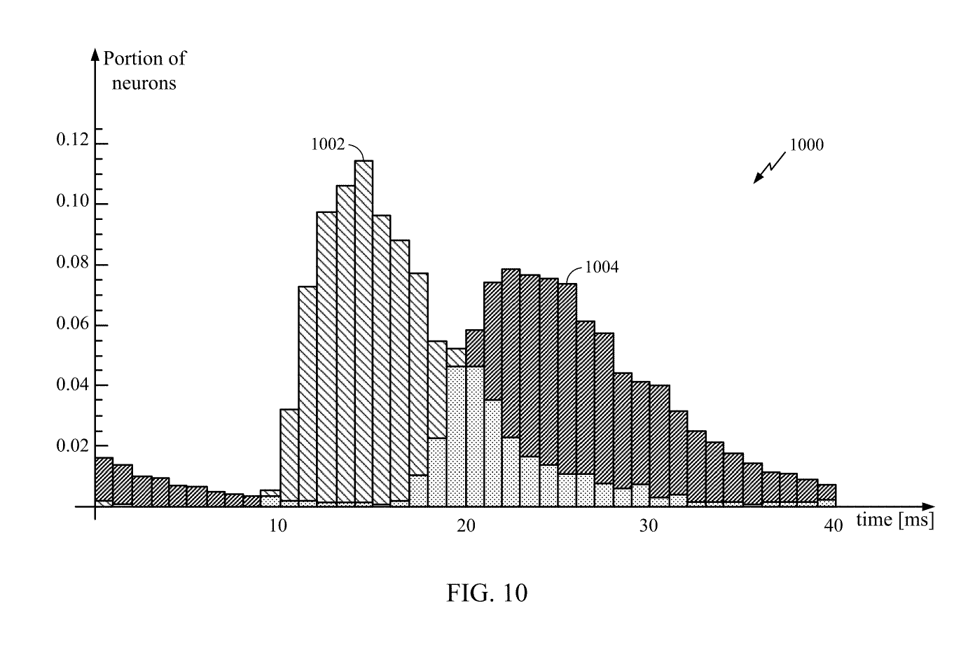

Another way to implement popout in the excitatory output can be to induce different time delays for the neurons from the popout region, and for those from the distractor region. FIG. 10 illustrates the hypothetical timing distribution 1000, with a portion 1002 being the distribution of desired popout spikes, and a portion 1004 being the distribution of spike timing for the distractors. The idea is that sufficient timing delays in the excitatory output will be read out as popout in a Superior Colliculus (SC) module of a multi-layer neural network.

### Simple/Complex Cell Emergence

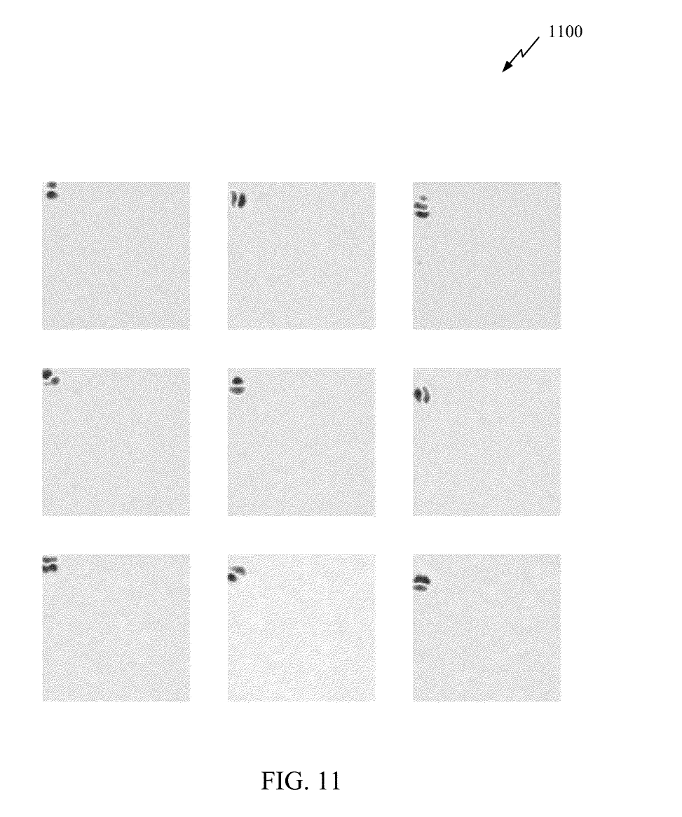

The first result to examine is the simple cell emergence. FIG. 11 illustrates a subsample 1100 of receptive fields for all L4 Magno neurons, computed by using Spike Trigger Average (STA) method. Magno represents the orientation selective pathway, while parvo represents the color pathway. Simple cells can be orientation selective cells. Emergence may occur due to exposure to visual stimuli with the respective features (such as simple cells in magno pathway being exposed to moving orientated bars or gratings). The STA method is a standard characterization method that measures receptive fields by the average rate-based activity of a cell to particular stimuli (orientations).

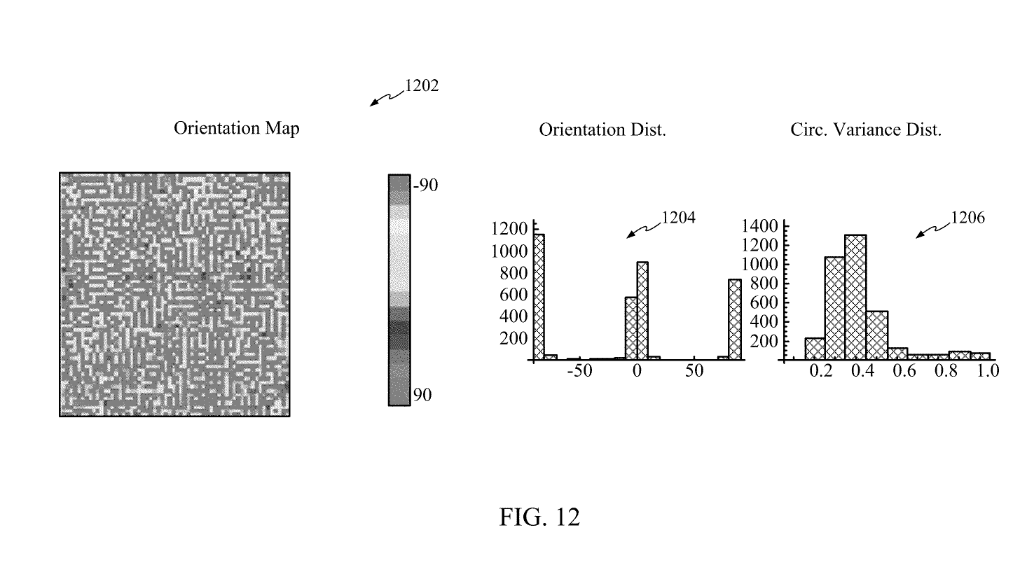

Moreover, the spatial uniformity and the evenness of feature distribution may need to be examined. Using L23 Magno neurons as an example, it can be observed, in a plot 1202 in FIG. 12, the spatial uniformity of the orientation feature for all L23 excitatory neurons in a multi-layer neural network. A plot 1204 illustrates the histogram for the spatial orientation feature having values between −90 and 90 degrees. A plot 1206 illustrates circular variance for the L23 excitatory neurons. Similar results can be expected for L23 inhibitory neurons. The circular variance represents the variance in the selectivity across orientation. Thus, the smaller the circular variance, the more directionally tuned the cell is. There is no difference in this respect between excitatory and inhibitory cell populations because they are independent of one another and differ only in that their output to subsequent cells (not inputs) are excitatory instead of inhibitory, respectively.

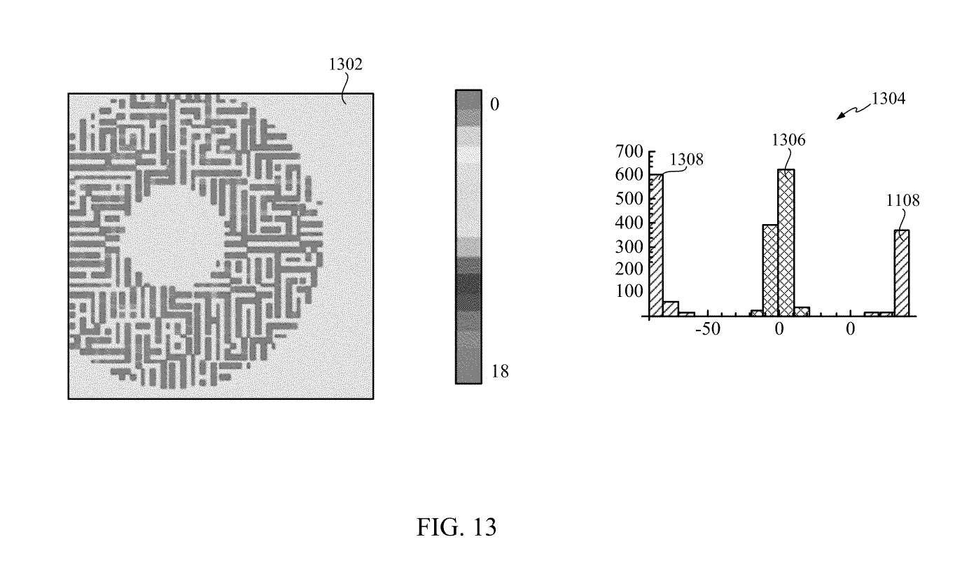

The resulting emerged long-range inhibition should have weights increased and decreased from initial such that the resulting strong connections are mostly, if not entirely, due to similar features between the pre-synaptic and post-synaptic neurons, as illustrated in an orientation map 1302 in FIG. 13. Another way to look at the results is to compare the orientation distribution pre- and post-training. A plot 1304 in FIG. 13 illustrates these two scenarios. As illustrated in FIG. 13, a portion 1306 represents the pre-training distribution, which is very similar to the plot 1202 in FIG. 12. The −90 and 90 orientations are not visible because they are almost completely overlapped by the post-training distribution. In other words, the post-training distribution in this case (illustrated with a histogram 1308 in FIG. 13), are only present in the −90 or 90 degrees, thereby validating the original design requirement.

Spike Activities after Long Range Training

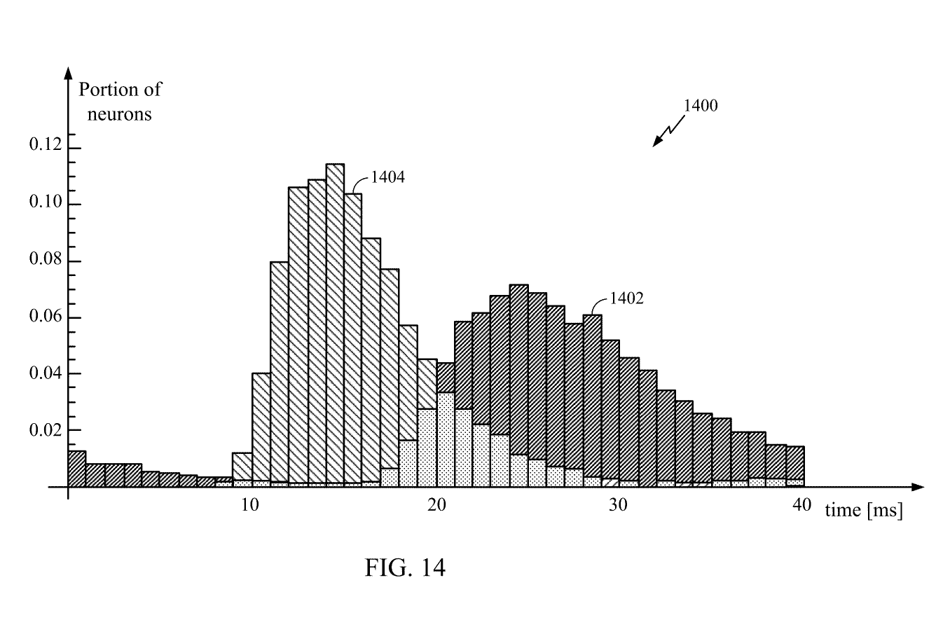

With the connected long-range inhibition, the activity of excitatory sub-layer should be suppressed, as illustrated in a graph 1400 in FIG. 14, i.e., in a histogram 1402 in FIG. 14 of excitatory sub-layer activity compared to the histogram 602 in FIG. 6. The activity of inhibitory sub-layer is illustrated with a histogram 1404 in FIG. 14. By design, firing of long-range inhibitory neurons may be in advance of neurons of the excitatory sub-layer, e.g., by approximately 10 ms on average. In an aspect of the present disclosure, the shape of LTP portion of the STDP learning curve may be designed such that the STDP captures causal arrangements. The long-range inhibition may emerge as the distractor suppression mechanism.

Distractors are responses to features that are not unique. Distractors may occur because there is insufficient suppression of the common feature response either because there is no nearby response with the same orientation or the feature detection is poor. Distractors may thus be suppressed by improving the uniformity and performance of feature detection and the range of inhibition so that even more distance same-feature responses can suppress the non-unique distractor. For example, there may be only one horizontal bar detection cell in a local area. Even if there are horizontal bars all over the visual field, the cell may fire and suggest, incorrectly, that there is a salient single unique horizontal bar. This is a distractor because there are actually more horizontal bars. In order to fix this, one can wire in inhibition from more remote horizontal cells or improve the uniformity by developing more horizontal cell responses in the vicinity of the distractor.

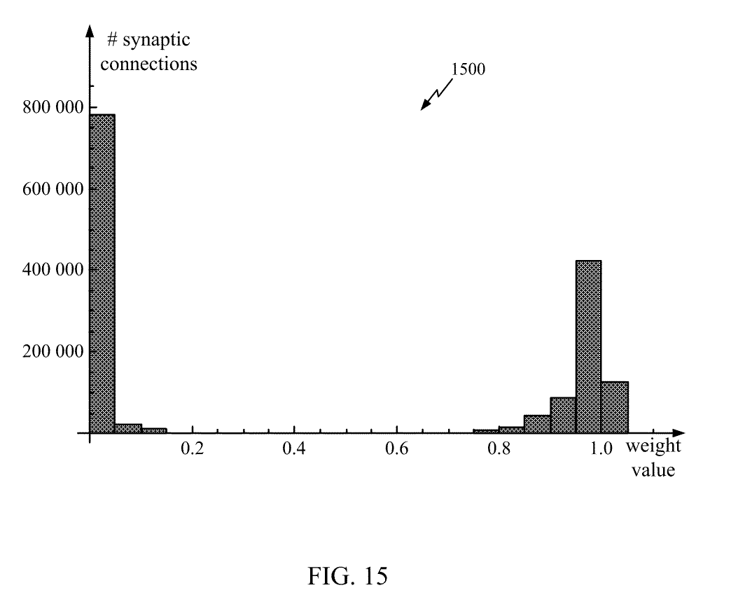

After training, examination of the ratio r between the number of zero weights and the number of non-zero weights in the long-range inhibitory fan-out connections may provide indication of whether the long-range lateral inhibition has properly emerged depending on how the feature space is partitioned and spatially distributed. The ratio should be relatively on par with the portion of cells having common receptive fields (e.g., in different locations). Typically, with the classical STDP learning rule, synaptic weights may converge to a bimodal distribution, wherein most of synaptic weights may have values of only zero and one, an example of which is illustrated with a histogram 1500 in FIG. 15. It should be noted, in the histogram 1500, the ratio/distribution of weights near zero (minimum) and one (maximum).

### Inhibitory Neuron Activities During Popout

Independently of the proper emergence of a long-range synapse connecting an inhibitory neuron with an excitatory neuron, there are necessary conditions on the inhibitory neurons in order for popout to work. First, true-negative signals may need to be present in the inhibitory neurons response, because they are responsible for suppressing the distractors in the excitatory neurons. Second, average false positive signals may need to be significantly lower than the true-positive responses.

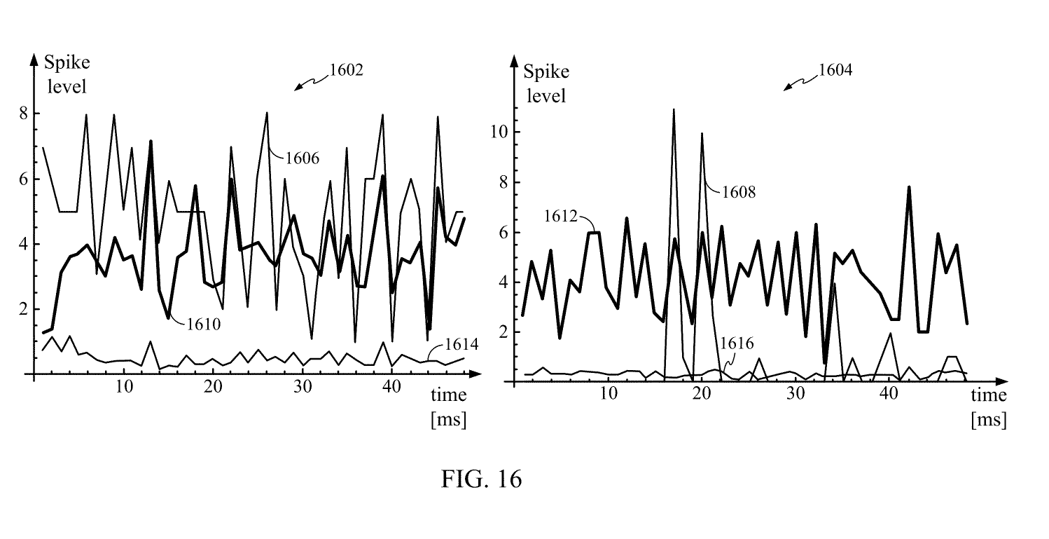

FIG. 16 illustrates sample plots 1602 and 1604 for two inhibitory neurons during popout tests in accordance with certain aspects of the present disclosure. Curves 1606 and 1608 are the true positives, curves 1610 and 1612 are the true negatives, and curves 1614 and 1616 are the false positive responses. A popout test typically comprises exposing a system to input with unique features embedded among non-unique features (such as an image of horizontal bars with a single vertical bar) and confirming that the unique feature is detected as salient.

### Spike Output for Orientation Popout

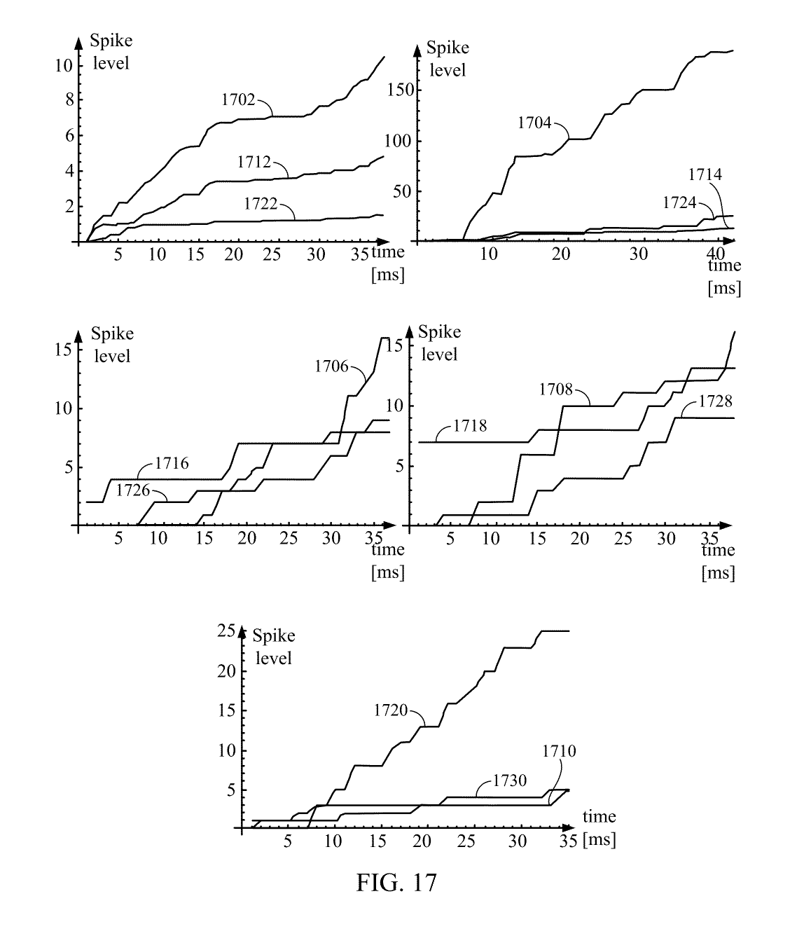

As discussed above, the expected output in the excitatory neurons for a popout response can be represented as cumulative spike activities dominant in the popout region compared to the rest of the visual field. FIG. 17 illustrates a subset of the cumulative spike activities during different popout trials in accordance with certain aspects of the present disclosure. Curves 1702-1710 are the true positives, curves 1712-1720 are the true negatives, and curves 1722-1730 are the false positive responses.

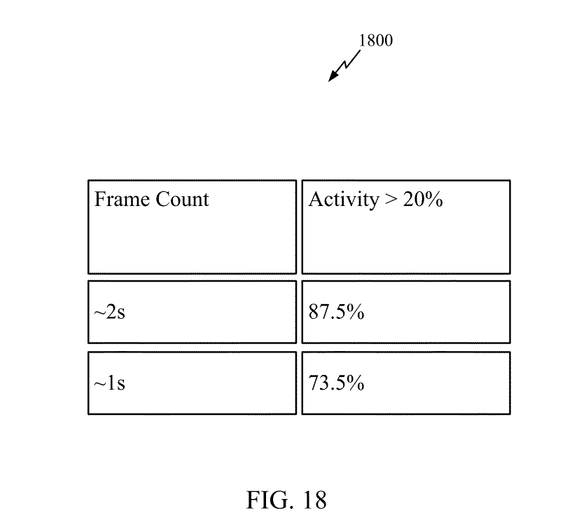

Based on this output pattern, one can devise a popout scheme that accumulates spike activities for n frames of input signals, and make a saccadic decision based on the most active region. The table 1800 in FIG. 18 reflects the potential performance of this popout scheme. This popout readout scheme refers to determining the unique feature that is detected as salient based on accumulation of spiking response by a unique cell or set of cells responding to that feature in the particular location.

### Saliency Readout

Certain aspects of the present disclosure support different readout designs. The information for popout (saliency) may be coded in the firing of the excitatory sub-layer cells. In an aspect of the present disclosure, that information may be coded by the rate of firing over spatial density (area of highest firing may be a target). In another aspect, that information may be coded by the timing of firing (area of earliest firing may be a target). In the case of rate-based popout, output spikes at on-target location may exceed spikes at off-target locations. In the case of response-time based popout, output spikes at on-target location may be faster than spikes at off-target locations.

However, there are also some alternative readout methods. In one aspect, the readout may be determined, after a pre-determined time, as an area with the most accumulated spikes. In another aspect, the readout may be determined when a spike count in any given area exceeds a pre-determined threshold. In yet another aspect, the readout may be determined when a pre-determined time is reached, if spiking in any area exceeds an accumulated count.

General approach to development/emergence may comprise several operational steps. In an aspect of the present disclosure, Hunzinger Cold cell dynamics (parameters) may be determined to obtain firing subsequent to desired contributing inputs (elements of features to be detected). The Hunzinger Cold neuron model may comprise two or more regimes (aspects) including a leaky sub-threshold regime (called the negative regime resembling behavior of leaky-integrate-and-fire (LIF)) and a super-threshold regime (called the positive or anti-leaky-integrate-and-fire (ALIF) regime). For example, time constants for the ALIF regime may accelerate or decelerate to position firing in time relative to input (excitatory and inhibitory). Time constants for the LIF regime and threshold/weight scaling may be determined to fit desired input feature elements (number and temporal distribution). Further, programmable delays can be optionally utilized for positioning of spikes in relative time.

In an aspect of the present disclosure, inhibition firing may precede excitatory firing that is to be suppressed. Local inhibition may be used to suppress common response in nearby cells. Extent of lateral inhibitory connectivity of neuron circuits may be determined to coincide with desired uniformity. Strength of inhibition of neuron circuits may be determined to coincide with a desired output: complete suppression (rate readout) or delay of a subpopulation of targets (timing readout). The rate readout is a readout based on a rate of response (spikes per second or total number of spikes—e.g., more spikes or higher rate may correspond to more significant value).

The timing readout is a readout based on time instants when spikes occur (e.g., earlier spike may correspond to more significant value).

In an aspect of the present disclosure, an input may be determined such that a desired input signal occurs before cell firing within a chosen window and across a given spatial area/pattern. The STDP learning curve may be determined such that the shape of LTP portion is suitable to include correlated input signals (elements of features), and the shape of LTD portion is suitable to include non-causal inputs (i.e., when a post-synaptic spike precedes a pre-synaptic spike) and inputs outside the defined time window. This may be executed with plasticity to develop orientation selective, distributed and uniform feature detection layer(s).

Certain aspects of the present disclosure support emergent popout in the same layer as feature detection. In an aspect, the popout may be achieved by suppressing response of feature detector (excitatory) cells using a feature selective long-range inhibitory layer that fire in advance of an excitatory layer. A long-range “donut” connection pattern may be utilized for long-range inhibition in addition to local inhibition. In a particular embodiment, long-range connections may be initialized to zero (or near zero or being disconnected) and/or plasticity may be turned-off for long-range connection output to excitatory layer.

In an aspect of the present disclosure, excitatory cell neuron parameters and inhibitory (long-range) cell neuron parameters may be determined so that inhibitory cells are faster and fire a pre-determined amount of time in advance of excitatory cells. Developing of feature detection may be achieved in both excitatory cells and long-range inhibitory cells according to aforementioned techniques. Both excitatory and long-range inhibitory sub-layers may be developed to be selective, distributed and uniform—the main difference is that inhibitory cells may be designed to fire earlier than excitatory cells.

In an aspect of the present disclosure, a process of annealing of synaptic weights (or freezing of synaptic weights) may be performed for feature detection learning (feed-forward and local lateral) in the case of both excitatory and inhibitory sub-layers. Annealing is a process of hardening or progressively reducing flexibility or plasticity in weights. At an extreme extend, annealing may be applied at a single instant before which weights are fully plastic and after which weights can be frozen. Plasticity for long-range connections may be turned on from inhibitory long range to excitatory. The STDP may be used as above to learn causal connectivity between neuron circuits of a long-range inhibitory layer and neuron circuits of an excitatory feature detection layer of the multi-layer spiking neural network. Based on the learning of causal connectivity, synaptic weights from long-range inhibition cells to excitatory feature detection cells may be determined.

In an aspect of the present disclosure, the information for popout may be coded in the firing of the excitatory cells. Coding of that information may be achieved by the rate of firing over spatial density (area of highest firing is target) or by the timing of firing (area of earliest firing is target).

However, there can be many other possible readouts including: determining readout after a pre-determined time as the area with the most accumulated spikes, determining readout when spike count in any given area exceeds a pre-determined threshold, and determining readout when a pre-determined time is reached if spiking in any area exceeds an accumulated count.

There may be a conflict in attempting to build both feature detection and popout in the same layer. This can be avoided if the feature detection layer is not corrupted with popout. This may be achieved by adding an additional layer on top and wiring the long-range inhibitory connections to that additional layer instead of the feature detection layer (complex cells).

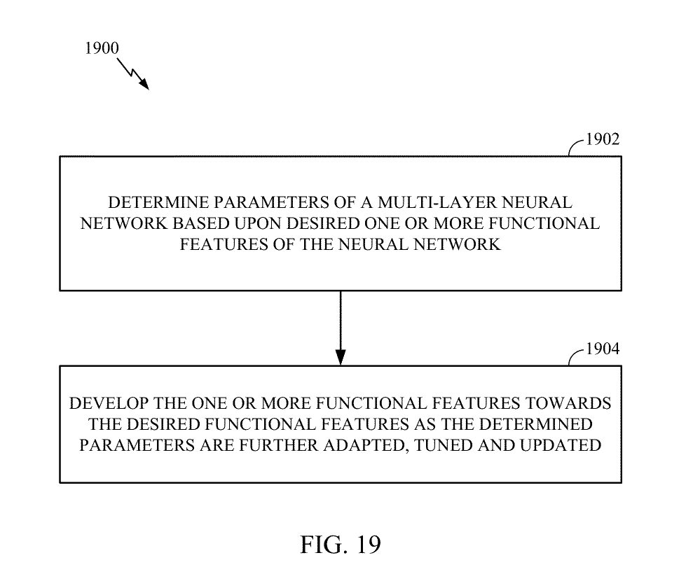

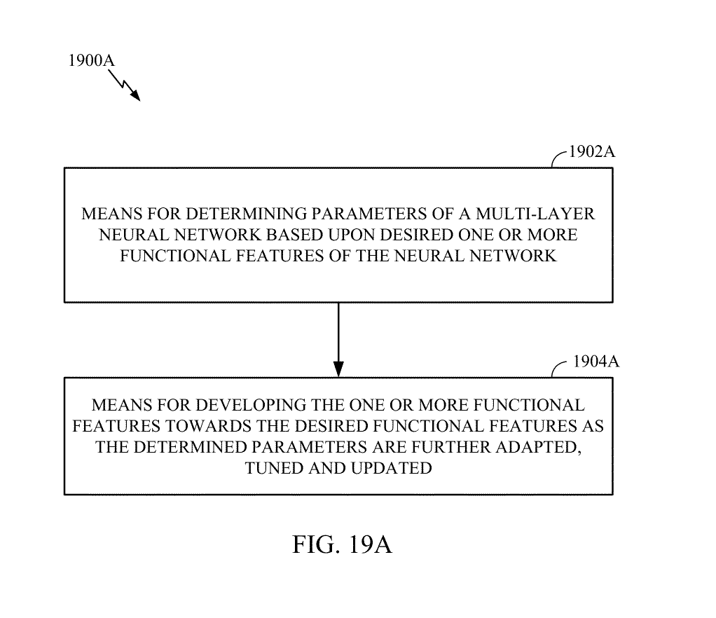

FIG. 19 illustrates example operations 1900 for designing an emergent multi-layer spiking neural network in accordance with certain aspects of the present disclosure. At 1902, parameters of the neural network may be determined based upon desired one or more functional features of the neural network. At 1904, the one or more functional features may be developed towards the desired functional features as the determined parameters are further adapted, tuned and updated. The parameters may comprise at least one of time constants of neuron circuits of the neural network, time constants of synapse connections of the neural network, timing parameters of the neural network, or timing aspects of learning in the neural network. The one or more functional features may comprise at least one of feature detection in a layer of the multi-layer spiking neural network or saliency detection in another layer of the multi-layer spiking neural network.

In an aspect of the present disclosure, the one or more functional features may be developed towards the desired functional features in a time evolving scheme as the parameters are adapted, tuned and updated over time. In another aspect of the present disclosure, the one or more functional features may be further developed towards the desired functional features in an iterative scheme as the parameters are adapted, tuned and updated based on the previously developed one or more functional features.

In an aspect of the present disclosure, determining the at least one of neuron time constants, connection time constants, timing parameters or timing aspects of learning may comprise adjusting the neuron time constants, the connection time constants and a shape of spike-timing dependent plasticity (STDP) learning curve related to the timing aspects of learning such that input and output aspects of the neural network desired to be correlated match with potentiation regions of the STDP learning curve, and undesired or non-distinctive aspects of the neural network match with depression regions of the STDP learning curve.

In an aspect of the present disclosure, determining the timing parameters comprises determining parameters related to first neuron circuits of an excitatory layer and parameters related to second neuron circuits of a long-range inhibitory layer of the multi-layer spiking neural network such that the second neuron circuits are faster and fire a pre-determined amount of time in advance of the first neuron circuits. Further, developing of feature detection may be achieved in both the first and second neuron circuits. In addition, annealing of synaptic weights may be applied for feature detection learning for both the first and second neuron circuits. In an aspect of the present disclosure, determining time constants of neuron circuits of the neural network comprises accelerating or decelerating time constants for ALIF aspect of a model of the neuron circuits to position firing in time relative to an input of an inhibitory sub-layer and to an input of an excitatory sub-layer of the multi-layer spiking neural network.

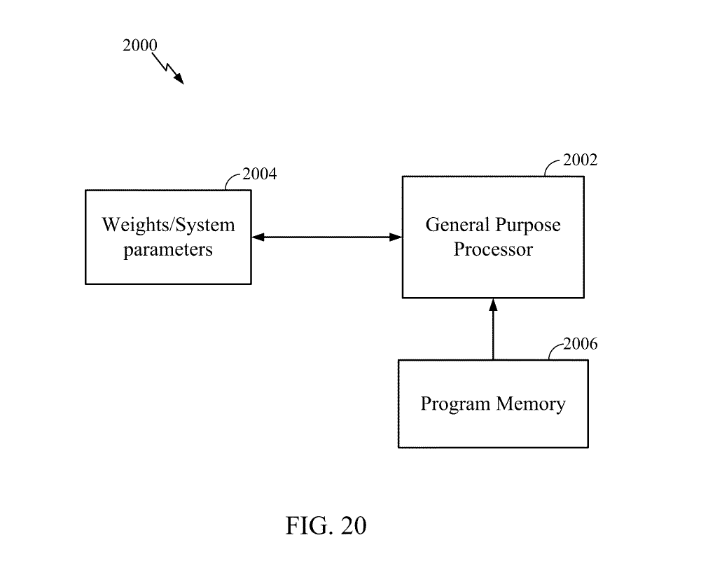

FIG. 20 illustrates an example implementation 2000 of the aforementioned method for designing an emergent multi-layer spiking neural network using a general-purpose processor 2002 in accordance with certain aspects of the present disclosure. Variables (neural signals), synaptic weights and system parameters associated with a computational network (neural network) may be stored in a memory block 2004, while instructions related executed at the general-purpose processor 2002 may be loaded from a program memory 2006. In an aspect of the present disclosure, the instructions loaded into the general-purpose processor 2002 may comprise code for determining parameters of the neural network based upon desired one or more functional features of the neural network, and code for developing the one or more functional features towards the desired functional features as the determined parameters are further adapted, tuned and updated.

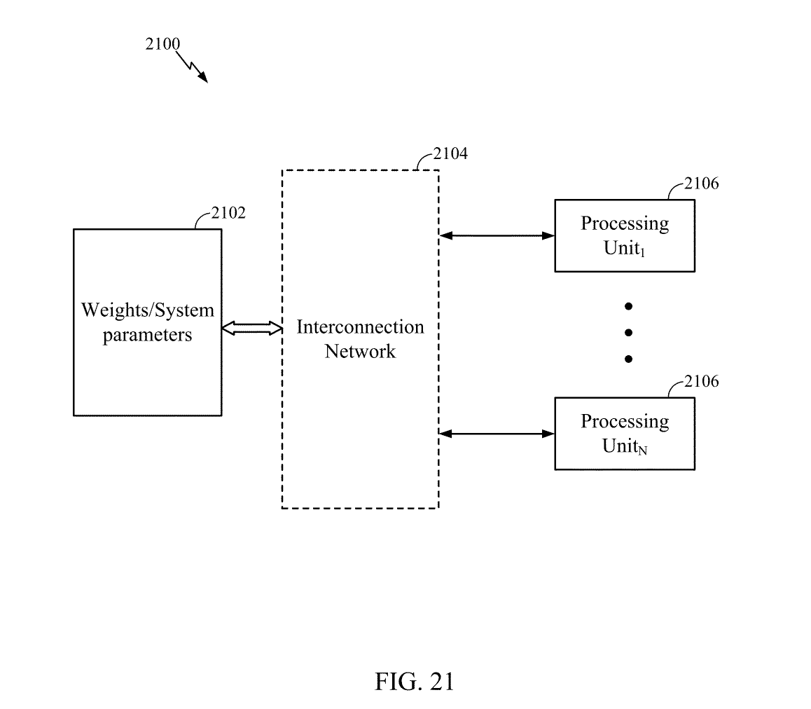

FIG. 21 illustrates an example implementation 2100 of the aforementioned method for designing an emergent multi-layer spiking neural network where a memory 2102 can be interfaced via an interconnection network 2104 with individual (distributed) processing units (neural processors) 2106 of a computational network (neural network) in accordance with certain aspects of the present disclosure. Variables (neural signals), synaptic weights and system parameters associated with the computational network (neural network) may be stored in the memory 2102, and may be loaded from the memory 2102 via connection(s) of the interconnection network 2104 into each processing unit (neural processor) 2106. In an aspect of the present disclosure, the processing unit 2106 may be configured to determine parameters of the neural network based upon desired one or more functional features of the neural network, and develop the one or more functional features towards the desired functional features as the determined parameters are further adapted, tuned and updated.

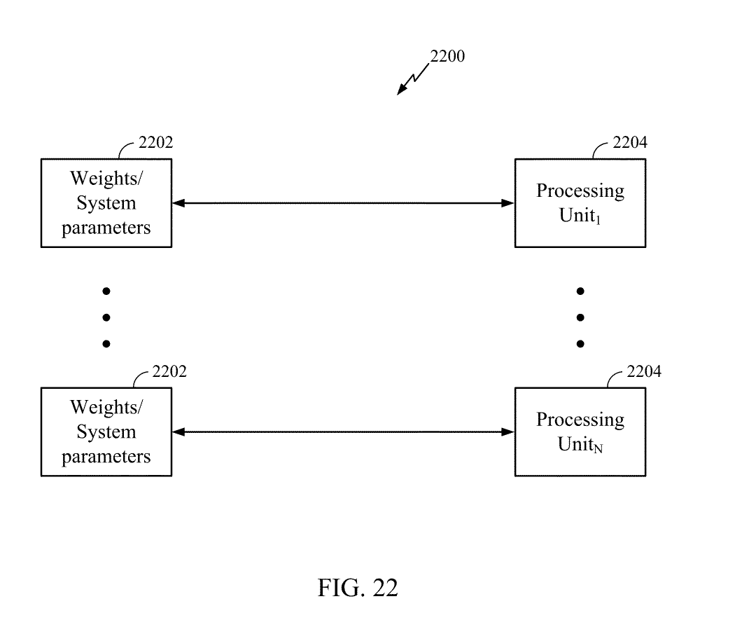

FIG. 22 illustrates an example implementation 2200 of the aforementioned method for designing an emergent multi-layer spiking neural network based on distributed weight memories 2202 and distributed processing units (neural processors) 2204 in accordance with certain aspects of the present disclosure. As illustrated in FIG. 22, one memory bank 2202 may be directly interfaced with one processing unit 2204 of a computational network (neural network), wherein that memory bank 2202 may store variables (neural signals), synaptic weights and system parameters associated with that processing unit (neural processor) 2204. In an aspect of the present disclosure, the processing unit 2204 may be configured to determine parameters of the neural network based upon desired one or more functional features of the neural network, and develop the one or more functional features towards the desired functional features as the determined parameters are further adapted, tuned and updated.

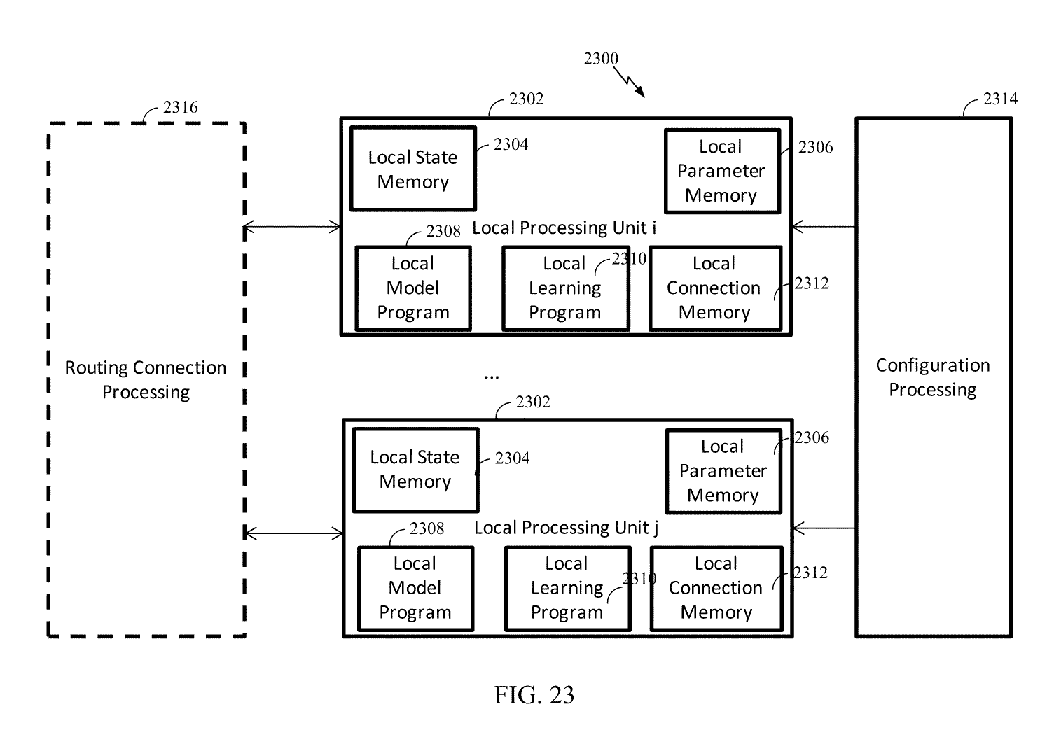

FIG. 23 illustrates an example implementation of a neural network 2300 in accordance with certain aspects of the present disclosure. As illustrated in FIG. 23, the neural network 2300 may comprise a plurality of local processing units 2302 that may perform various operations of methods described above. Each processing unit 2302 may comprise a local state memory 2304 and a local parameter memory 2306 that store parameters of the neural network. In addition, the processing unit 2302 may comprise a memory 2308 with local (neuron) model program, a memory 2310 with local learning program, and a local connection memory 2312. Furthermore, as illustrated in FIG. 23, each local processing unit 2302 may be interfaced with a unit 2314 for configuration processing that may provide configuration for local memories of the local processing unit, and with routing connection processing elements 2316 that provide routing between the local processing units 2302.

According to certain aspects of the present disclosure, each local processing unit 2302 may be configured to determine parameters of the neural network based upon desired one or more functional features of the neural network, and develop the one or more functional features towards the desired functional features as the determined parameters are further adapted, tuned and updated.

According to certain aspects of the present disclosure, the operations 1900 illustrated in FIG. 19 may be performed in hardware, e.g., by one or more processing units 2302 from FIG. 23.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in Figures, those operations may have corresponding counterpart means-plus-function components with similar numbering. For example, operations 1900 illustrated in FIG. 19 correspond to components 1900A illustrated in FIG. 19A.

For example, means for accelerating may comprise an application specific integrated circuit, e.g., the general-purpose processor 2002 from FIG. 20, one or more of the processing units 2106 from FIG. 21, one or more of the processing units 2204 from FIG. 22, or one or more of the processing units 2302 from FIG. 23. Means for achieving may comprise an application specific integrated circuit, e.g., the general-purpose processor 2002, one or more of the processing units 2106, one or more of the processing units 2204, or one or more of the processing units 2302. Means for adjusting may comprise an application specific integrated circuit, e.g., the general-purpose processor 2002, one or more of the processing units 2106, one or more of the processing units 2204, or one or more of the processing units 2302. Means for annealing of synaptic weights may comprise an application specific integrated circuit, e.g., the general-purpose processor 2002, one or more of the processing units 2106, one or more of the processing units 2204, or one or more of the processing units 2302. Means for coding information may comprise an application specific integrated circuit, e.g., the general-purpose processor 2002, one or more of the processing units 2106, one or more of the processing units 2204, or one or more of the processing units 2302. Means for determining may comprise an application specific integrated circuit, e.g., the general-purpose processor 2002, one or more of the processing units 2106, one or more of the processing units 2204, or one or more of the processing units 2302. Means for determining parameters related to neuron circuits may comprise an application specific integrated circuit, e.g., the general-purpose processor 2002, one or more of the processing units 2106, one or more of the processing units 2204, or one or more of the processing units 2302. Means for determining readout may comprise an application specific integrated circuit, e.g., the general-purpose processor 2002, one or more of the processing units 2106, one or more of the processing units 2204, or one or more of the processing units 2302. Means for determining readout after a pre-determined time may comprise an application specific integrated circuit, e.g., the general-purpose processor 2002, one or more of the processing units 2106, one or more of the processing units 2204, or one or more of the processing units 2302. Means for determining time constants may comprise an application specific integrated circuit, e.g., the general-purpose processor 2002, one or more of the processing units 2106, one or more of the processing units 2204, or one or more of the processing units 2302. Means for developing of feature detection may comprise an application specific integrated circuit, e.g., the general-purpose processor 2002, one or more of the processing units 2106, one or more of the processing units 2204, or one or more of the processing units 2302. Means for firing of neuron circuits of a neural network may comprise an application specific integrated circuit, e.g., the general-purpose processor 2002, one or more of the processing units 2106, one or more of the processing units 2204, or one or more of the processing units 2302. Means for suppressing firing of neuron circuits of a neural network may comprise an application specific integrated circuit, e.g., the general-purpose processor 2002, one or more of the processing units 2106, one or more of the processing units 2204, or one or more of the processing units 2302. Means for turning on plasticity for long-range synaptic connections may comprise an application specific integrated circuit, e.g., the general-purpose processor 2002, one or more of the processing units 2106, one or more of the processing units 2204, or one or more of the processing units 2302.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an ASIC (Application Specific Integrated Circuit) with the processor, the bus interface, the user interface, supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A method of designing an emergent multi-layer spiking neural network, comprising:
determining parameters of the neural network based upon desired one or more functional features of the neural network; and
developing the one or more functional features towards the desired functional features as the determined parameters are further modified.

2. The method of claim 1, wherein the parameters comprise at least one of time constants of neuron circuits of the neural network, time constants of synapse connections of the neural network, timing parameters of the neural network, or timing aspects of learning in the neural network.

3. The method of claim 2, wherein the time constants of neuron circuits comprises leaky-integrate-and-fire (LIF) time constant and anti-leaky-integrate-and-fire (ALIF) time constant.

4. The method of claim 1, wherein the one or more functional features are developed towards the desired functional features in a time evolving scheme as the parameters are adapted, tuned and updated over time.

5. The method of claim 1, wherein the one or more functional features are further developed towards the desired functional features in an iterative scheme as the parameters are adapted, tuned and updated based on the previously developed one or more functional features.

6. The method of claim 1, wherein determining the parameters comprises constraining search for values of the parameters.

7. The method of claim 1, wherein the one or more functional features comprises at least one of feature detection in a layer of the multi-layer spiking neural network or saliency detection in another layer of the multi-layer spiking neural network.

8. The method of claim 7, further comprising:
achieving the saliency detection by suppressing response of neuron circuits of an excitatory layer of the multi-layer spiking neural network using a feature selective long-range inhibitory layer of the multi-layer spiking neural network that fires in advance of the excitatory layer.

9. The method of claim 7, further comprising:
coding information for the saliency detection in firing of neuron circuits of the other layer of the multi-layer spiking neural network.

10. The method of claim 9, wherein coding information for the saliency detection comprises:
coding information in firing of excitatory neuron circuits of the other layer by a rate of firing over a spatial density.

11. The method of claim 9, wherein coding information for the saliency detection comprises:
coding information in firing of excitatory neuron circuits of the other layer by timing of firing.

12. The method of claim 1, wherein developing the one or more functional features comprises:
developing feature detection at a circuit of the multi-layer neural network; and
developing saliency detection at another circuit of the multi-layer neural network.

13. The method of claim 1, wherein determining the parameters comprises:
accelerating or decelerating time constants for anti-leaky-integrate-and-fire (ALIF) aspect of a model of neuron circuits of the neural network to position firing in time relative to an input of an inhibitory sub-layer and to an input of an excitatory sub-layer of the multi-layer spiking neural network.

14. The method of claim 1, wherein determining the parameters comprises:
determining time constants for leaky-integrate-and-fire (LIF) aspect of a model of neuron circuits of the neural network and synaptic weight scaling to fit desired input feature elements.

15. The method of claim 1, further comprising:
firing of neuron circuits of an inhibitory sub-layer of the multi-layer spiking neural network such that to precede firing of neuron circuits of an excitatory sub-layer of the multi-layer spiking neural network; and
suppressing firing of neuron circuits of the excitatory sub-layer.

16. The method of claim 1, wherein determining the parameters comprises:
determining an extent of lateral inhibitory connectivity of neuron circuits of the multi-layer spiking neural network to coincide with a desired uniformity; and
determining a strength of inhibition of neuron circuits of the multi-layer spiking neural network to coincide with a desired output.

17. The method of claim 1, wherein the determining the parameters comprises:
determining an input of a neuron circuit of the multi-layer spiking neural network such that a desired input signal occurs before firing of the neuron circuit within a chosen window and across a given spatial area of the multi-layer spiking neural network.

18. The method of claim 2, wherein determining the at least one of neuron time constants, connection time constants, timing parameters, or timing aspects of learning comprises:
adjusting the neuron time constants, the connection time constants and a shape of spike-timing dependent plasticity (STDP) learning curve related to the timing aspects of learning such that input and output aspects of the neural network desired to be correlated match with potentiation regions of the STDP learning curve, and undesired or non-distinctive aspects of the neural network match with depression regions of the STDP learning curve.

19. The method of claim 18, further comprising:
using the STDP curve to learn causal connectivity between neuron circuits of a long-range inhibitory layer and neuron circuits of an excitatory feature detection layer of the multi-layer spiking neural network.

20. The method of claim 19, further comprising:
determining, based on the learning of causal connectivity, synaptic weights from the neuron circuits of the long-range inhibitory layer to the neuron circuits of the excitatory feature detection layer.

21. The method of claim 1, wherein determining the parameters comprises:
determining timing parameters related to first neuron circuits of an excitatory layer and timing parameters related to second neuron circuits of a long-range inhibitory layer of the multi-layer spiking neural network such that the second neuron circuits are faster and fire a pre-determined amount of time in advance of the first neuron circuits.

22. The method of claim 21, further comprising:
developing of feature detection in both the first and second neuron circuits.

23. The method of claim 21, further comprising:
annealing of synaptic weights for feature detection learning for both the first and second neuron circuits.

24. The method of claim 21, further comprising:
turning on plasticity for long-range synaptic connections from the second neuron circuits to the first neuron circuits.

25. The method of claim 1, further comprising:
determining readout after a pre-determined time as an area of the multi-layer spiking neural network with the most accumulated spikes.

26. The method of claim 1, further comprising:
determining readout when a spike count in any area of the multi-layer spiking neural network exceeds a pre-determined threshold.

27. The method of claim 1, further comprising:
determining readout when a pre-determined time is reached if spiking in any area of the multi-layer spiking neural network exceeds an accumulated count.

28. An apparatus for designing an emergent multi-layer spiking neural network, comprising:
a first circuit configured to determine parameters of the neural network based upon desired one or more functional features of the neural network; and
a second circuit configured to develop the one or more functional features towards the desired functional features as the determined parameters are further modified.

29. The apparatus of claim 28, wherein the parameters comprise at least one of time constants of neuron circuits of the neural network, time constants of synapse connections of the neural network, timing parameters of the neural network, or timing aspects of learning in the neural network.

30. The apparatus of claim 29, wherein the time constants of neuron circuits comprises leaky-integrate-and-fire (LIF) time constant and anti-leaky-integrate-and-fire (ALIF) time constant.

31. The apparatus of claim 28, wherein the one or more functional features are developed towards the desired functional features in a time evolving scheme as the parameters are adapted, tuned and updated over time.

32. The apparatus of claim 28, wherein the one or more functional features are further developed towards the desired functional features in an iterative scheme as the parameters are adapted, tuned and updated based on the previously developed one or more functional features.

33. The apparatus of claim 28, wherein the first circuit configured to determine the parameters is also configured to constrain search for values of the parameters.

34. The apparatus of claim 28, wherein the one or more functional features comprises at least one of feature detection in a layer of the multi-layer spiking neural network or saliency detection in another layer of the multi-layer spiking neural network.

35. The apparatus of claim 34, further comprising:
a third circuit configured to achieve the saliency detection by suppressing response of neuron circuits of an excitatory layer of the multi-layer spiking neural network using a feature selective long-range inhibitory layer of the multi-layer spiking neural network that fires in advance of the excitatory layer.

36. The apparatus of claim 34, further comprising:
a third circuit configured to code information for the saliency detection in firing of neuron circuits of the other layer of the multi-layer spiking neural network.

37. The apparatus of claim 36, wherein the third circuit is also configured to:
code information in firing of excitatory neuron circuits of the other layer by a rate of firing over a spatial density.

38. The apparatus of claim 36, wherein the third circuit is also configured to:
code information in firing of excitatory neuron circuits of the other layer by timing of firing.

39. The apparatus of claim 28, wherein the second circuit is also configured to:
develop feature detection at a circuit of the multi-layer neural network; and
develop saliency detection at another circuit of the multi-layer neural network.

40. The apparatus of claim 28, wherein the first circuit is also configured to:
accelerate or decelerate time constants for anti-leaky-integrate-and-fire (ALIF) aspect of a model of neuron circuits of the neural network to position firing in time relative to an input of an inhibitory sub-layer and to an input of an excitatory sub-layer of the multi-layer spiking neural network.

41. The apparatus of claim 28, wherein the first circuit is also configured to:
determine time constants for leaky-integrate-and-fire (LIF) aspect of a model of neuron circuits of the neural network and synaptic weight scaling to fit desired input feature elements.

42. The apparatus of claim 28, further comprising:
a third circuit configured to fire neuron circuits of an inhibitory sub-layer of the multi-layer spiking neural network such that to precede firing of neuron circuits of an excitatory sub-layer of the multi-layer spiking neural network; and
a fourth circuit configured to suppress firing of neuron circuits of the excitatory sub-layer.

43. The apparatus of claim 28, wherein the first circuit is also configured to:
determine an extent of lateral inhibitory connectivity of neuron circuits of the multi-layer spiking neural network to coincide with a desired uniformity; and
determine a strength of inhibition of neuron circuits of the multi-layer spiking neural network to coincide with a desired output.

44. The apparatus of claim 28, wherein the first circuit is also configured to:
determine an input of a neuron circuit of the multi-layer spiking neural network such that a desired input signal occurs before firing of the neuron circuit within a chosen window and across a given spatial area of the multi-layer spiking neural network.

45. The apparatus of claim 29, wherein the first circuit is also configured to:
adjust the neuron time constants, the connection time constants and a shape of spike-timing dependent plasticity (STDP) learning curve related to the timing aspects of learning such that input and output aspects of the neural network desired to be correlated match with potentiation regions of the STDP learning curve, and undesired or non-distinctive aspects of the neural network match with depression regions of the STDP learning curve.

46. The apparatus of claim 45, further comprising:
a third circuit configured to use the STDP curve to learn causal connectivity between neuron circuits of a long-range inhibitory layer and neuron circuits of an excitatory feature detection layer of the multi-layer spiking neural network.

47. The apparatus of claim 46, further comprising:
a fourth circuit configured to determine, based on the learning of causal connectivity, synaptic weights from the neuron circuits of the long-range inhibitory layer to the neuron circuits of the excitatory feature detection layer.

48. The apparatus of claim 28, wherein the first circuit is also configured to:
determine timing parameters related to first neuron circuits of an excitatory layer and timing parameters related to second neuron circuits of a long-range inhibitory layer of the multi-layer spiking neural network such that the second neuron circuits are faster and fire a pre-determined amount of time in advance of the first neuron circuits.

49. The apparatus of claim 48, further comprising:
a third circuit configured to develop feature detection in both the first and second neuron circuits.

50. The apparatus of claim 48, further comprising:
a third circuit configured to anneal synaptic weights for feature detection learning for both the first and second neuron circuits.

51. The apparatus of claim 48, further comprising:
a third circuit configured to turn on plasticity for long-range synaptic connections from the second neuron circuits to the first neuron circuits.

52. The apparatus of claim 28, further comprising:
a third circuit configured to determine readout after a pre-determined time as an area of the multi-layer spiking neural network with the most accumulated spikes.

53. The apparatus of claim 28, further comprising:
a third circuit configured to determine readout when a spike count in any area of the multi-layer spiking neural network exceeds a pre-determined threshold.

54. The apparatus of claim 28, further comprising:
a third circuit configured to determine readout when a pre-determined time is reached if spiking in any area of the multi-layer spiking neural network exceeds an accumulated count.

55. An apparatus for designing an emergent multi-layer spiking neural network, comprising:
means for determining parameters of the neural network based upon desired one or more functional features of the neural network; and
means for developing the one or more functional features towards the desired functional features as the determined parameters are further modified.

56. The apparatus of claim 55, wherein the parameters comprise at least one of time constants of neuron circuits of the neural network, time constants of synapse connections of the neural network, timing parameters of the neural network, or timing aspects of learning in the neural network.

57. The apparatus of claim 56, wherein the time constants of neuron circuits comprises leaky-integrate-and-fire (LIF) time constant and anti-leaky-integrate-and-fire (ALIF) time constant.

58. The apparatus of claim 55, wherein the one or more functional features are developed towards the desired functional features in a time evolving scheme as the parameters are adapted, tuned and updated over time.

59. The apparatus of claim 55, wherein the one or more functional features are further developed towards the desired functional features in an iterative scheme as the parameters are adapted, tuned and updated based on the previously developed one or more functional features.

60. The apparatus of claim 55, wherein the means for determining the parameters further comprises means for constraining search for values of the parameters.

61. The apparatus of claim 55, wherein the one or more functional features comprises at least one of feature detection in a layer of the multi-layer spiking neural network or saliency detection in another layer of the multi-layer spiking neural network.

62. The apparatus of claim 61, further comprising:
means for achieving the saliency detection by suppressing response of neuron circuits of an excitatory layer of the multi-layer spiking neural network using a feature selective long-range inhibitory layer of the multi-layer spiking neural network that fires in advance of the excitatory layer.

63. The apparatus of claim 61, further comprising:
means for coding information for the saliency detection in firing of neuron circuits of the other layer of the multi-layer spiking neural network.

64. The apparatus of claim 63, wherein the means for coding information for the saliency detection comprises:
means for coding information in firing of excitatory neuron circuits of the other layer by a rate of firing over a spatial density.

65. The apparatus of claim 63, wherein the means for coding information for the saliency detection comprises:
means for coding information in firing of excitatory neuron circuits of the other layer by timing of firing.

66. The apparatus of claim 55, wherein the means for developing the one or more functional features comprises:
means for developing feature detection at a circuit of the multi-layer neural network; and
means for developing saliency detection at another circuit of the multi-layer neural network.

67. The apparatus of claim 55, wherein the means for determining the parameters comprises:
means for accelerating or decelerating time constants for anti-leaky-integrate-and-fire (ALIF) aspect of a model of neuron circuits of the neural network to position firing in time relative to an input of an inhibitory sub-layer and to an input of an excitatory sub-layer of the multi-layer spiking neural network.

68. The apparatus of claim 55, wherein the means for determining the parameters comprises:
means for determining time constants for leaky-integrate-and-fire (LIF) aspect of a model of neuron circuits of the neural network and synaptic weight scaling to fit desired input feature elements.

69. The apparatus of claim 55, further comprising:
means for firing of neuron circuits of an inhibitory sub-layer of the multi-layer spiking neural network such that to precede firing of neuron circuits of an excitatory sub-layer of the multi-layer spiking neural network; and
means for suppressing firing of neuron circuits of the excitatory sub-layer.

70. The apparatus of claim 55, wherein the means for determining parameters comprises:
means for determining an extent of lateral inhibitory connectivity of neuron circuits of the multi-layer spiking neural network to coincide with a desired uniformity; and
means for determining a strength of inhibition of neuron circuits of the multi-layer spiking neural network to coincide with a desired output.

71. The apparatus of claim 55, wherein the means for determining parameters comprises:
means for determining an input of a neuron circuit of the multi-layer spiking neural network such that a desired input signal occurs before firing of the neuron circuit within a chosen window and across a given spatial area of the multi-layer spiking neural network.

72. The apparatus of claim 56, wherein the means for determining the at least one of neuron time constants, connection time constants, timing parameters, or timing aspects of learning comprises:
means for adjusting the neuron time constants, the connection time constants and a shape of spike-timing dependent plasticity (STDP) learning curve related to the timing aspects of learning such that input and output aspects of the neural network desired to be correlated match with potentiation regions of the STDP learning curve, and undesired or non-distinctive aspects of the neural network match with depression regions of the STDP learning curve.

73. The apparatus of claim 72, further comprising:
means for using the STDP curve to learn causal connectivity between neuron circuits of a long-range inhibitory layer and neuron circuits of an excitatory feature detection layer of the multi-layer spiking neural network.

74. The apparatus of claim 73, further comprising:
means for determining, based on the learning of causal connectivity, synaptic weights from the neuron circuits of the long-range inhibitory layer to the neuron circuits of the excitatory feature detection layer.

75. The apparatus of claim 55, wherein the means for determining parameters comprises:
means for determining timing parameters related to first neuron circuits of an excitatory layer and timing parameters related to second neuron circuits of a long-range inhibitory layer of the multi-layer spiking neural network such that the second neuron circuits are faster and fire a pre-determined amount of time in advance of the first neuron circuits.

76. The apparatus of claim 75, further comprising:
means for developing of feature detection in both the first and second neuron circuits.

77. The apparatus of claim 75, further comprising:
means for annealing of synaptic weights for feature detection learning for both the first and second neuron circuits.

78. The apparatus of claim 75, further comprising:
means for turning on plasticity for long-range synaptic connections from the second neuron circuits to the first neuron circuits.

79. The apparatus of claim 55, further comprising:
means for determining readout after a pre-determined time as an area of the multi-layer spiking neural network with the most accumulated spikes.

80. The apparatus of claim 55, further comprising:
means for determining readout when a spike count in any area of the multi-layer spiking neural network exceeds a pre-determined threshold.

81. The apparatus of claim 55, further comprising:
means for determining readout when a pre-determined time is reached if spiking in any area of the multi-layer spiking neural network exceeds an accumulated count.

82. A computer program product for designing an emergent multi-layer spiking neural network, comprising a computer-readable medium comprising code for:
determining parameters of the neural network based upon desired one or more functional features of the neural network; and
developing the one or more functional features towards the desired functional features as the determined parameters are further adapted, tuned and updated.

83. The computer program product of claim 82, wherein the parameters comprise at least one of time constants of neuron circuits of the neural network, time constants of synapse connections of the neural network, timing parameters of the neural network, or timing aspects of learning in the neural network.

84. The computer program product of claim 83, wherein the time constants of neuron circuits comprises leaky-integrate-and-fire (LIF) time constant and anti-leaky-integrate-and-fire (ALIF) time constant.

85. The computer program product of claim 82, wherein the one or more functional features are developed towards the desired functional features in a time evolving scheme as the parameters are adapted, tuned and updated over time.

86. The computer program product of claim 82, wherein the one or more functional features are further developed towards the desired functional features in an iterative scheme as the parameters are adapted, tuned and updated based on the previously developed one or more functional features.

87. The computer program product of claim 82, wherein determining the parameters comprises constraining search for values of the parameters.

88. The computer program product of claim 82, wherein the one or more functional features comprises at least one of feature detection in a layer of the multi-layer spiking neural network or saliency detection in another layer of the multi-layer spiking neural network.

89. The computer program product of claim 88, wherein the computer-readable medium further comprising code for:
achieving the saliency detection by suppressing response of neuron circuits of an excitatory layer of the multi-layer spiking neural network using a feature selective long-range inhibitory layer of the multi-layer spiking neural network that fires in advance of the excitatory layer.

90. The computer program product of claim 88, wherein the computer-readable medium further comprising code for:
coding information for the saliency detection in firing of neuron circuits of the other layer of the multi-layer spiking neural network.

91. The computer program product of claim 90, wherein the computer-readable medium further comprising code for:
coding information in firing of excitatory neuron circuits of the other layer by a rate of firing over a spatial density.

92. The computer program product of claim 90, wherein the computer-readable medium further comprising code for:
coding information in firing of excitatory neuron circuits of the other layer by timing of firing.

93. The computer program product of claim 82, wherein the computer-readable medium further comprising code for:
developing feature detection at a circuit of the multi-layer neural network; and
developing saliency detection at another circuit of the multi-layer neural network.

94. The computer program product of claim 82, wherein the computer-readable medium further comprising code for:
accelerating or decelerating time constants for anti-leaky-integrate-and-fire (ALIF) aspect of a model of neuron circuits of the neural network to position firing in time relative to an input of an inhibitory sub-layer and to an input of an excitatory sub-layer of the multi-layer spiking neural network.

95. The computer program product of claim 82, wherein the computer-readable medium further comprising code for:
determining time constants for leaky-integrate-and-fire (LIF) aspect of a model of neuron circuits of the neural network and synaptic weight scaling to fit desired input feature elements.

96. The computer program product of claim 82, wherein the computer-readable medium further comprising code for:
firing of neuron circuits of an inhibitory sub-layer of the multi-layer spiking neural network such that to precede firing of neuron circuits of an excitatory sub-layer of the multi-layer spiking neural network; and
suppressing firing of neuron circuits of the excitatory sub-layer.

97. The computer program product of claim 82, wherein the computer-readable medium further comprising code for:
determining an extent of lateral inhibitory connectivity of neuron circuits of the multi-layer spiking neural network to coincide with a desired uniformity; and
determining a strength of inhibition of neuron circuits of the multi-layer spiking neural network to coincide with a desired output.

98. The computer program product of claim 82, wherein the computer-readable medium further comprising code for:
determining an input of a neuron circuit of the multi-layer spiking neural network such that a desired input signal occurs before firing of the neuron circuit within a chosen window and across a given spatial area of the multi-layer spiking neural network.

99. The computer program product of claim 83, wherein the computer-readable medium further comprising code for:
adjusting the neuron time constants, the connection time constants and a shape of spike-timing dependent plasticity (STDP) learning curve related to the timing aspects of learning such that input and output aspects of the neural network desired to be correlated match with potentiation regions of the STDP learning curve, and undesired or non-distinctive aspects of the neural network match with depression regions of the STDP learning curve.

100. The computer program product of claim 99, wherein the computer-readable medium further comprising code for:
using the STDP curve to learn causal connectivity between neuron circuits of a long-range inhibitory layer and neuron circuits of an excitatory feature detection layer of the multi-layer spiking neural network.

101. The computer program product of claim 100, wherein the computer-readable medium further comprising code for:
determining, based on the learning of causal connectivity, synaptic weights from the neuron circuits of the long-range inhibitory layer to the neuron circuits of the excitatory feature detection layer.

102. The computer program product of claim 82, wherein the computer-readable medium further comprising code for:
determining timing parameters related to first neuron circuits of an excitatory layer and timing parameters related to second neuron circuits of a long-range inhibitory layer of the multi-layer spiking neural network such that the second neuron circuits are faster and fire a pre-determined amount of time in advance of the first neuron circuits.

103. The computer program product of claim 102, wherein the computer-readable medium further comprising code for:
developing of feature detection in both the first and second neuron circuits.

104. The computer program product of claim 102, wherein the computer-readable medium further comprising code for:
annealing of synaptic weights for feature detection learning for both the first and second neuron circuits.

105. The computer program product of claim 102, wherein the computer-readable medium further comprising code for:
turning on plasticity for long-range synaptic connections from the second neuron circuits to the first neuron circuits.

106. The computer program product of claim 82, wherein the computer-readable medium further comprising code for:
determining readout after a pre-determined time as an area of the multi-layer spiking neural network with the most accumulated spikes.

107. The computer program product of claim 82, wherein the computer-readable medium further comprising code for:
determining readout when a spike count in any area of the multi-layer spiking neural network exceeds a pre-determined threshold.

108. The computer program product of claim 82, wherein the computer-readable medium further comprising code for:
determining readout when a pre-determined time is reached if spiking in any area of the multi-layer spiking neural network exceeds an accumulated count.
